(19) United States
(12) Patent Application Publication
(10) Pub. No.: US 2025/0234340 A1
(43) Pub. Date: Jul. 17, 2025

(54) ADAPTIVE WAVEFORM SELECTION FOR WIRELESS COMMUNICATION

(71) Applicant: InterDigital Patent Holdings, Inc., Wilmington, DE (US)

(72) Inventors: Fumihiro Hasegawa, Westmount (CA); Virgil Comsa, Montreal (CA); Faris Alfarhan, Montreal (CA); Aata El Hamss, Laval (CA); Paul Marinier, Brossard (CA); Moon-il Lee, Melville, NY (US); Janet A. Stern-Berkowitz, Little Neck, NY (US); Frank LaSita, Long Beach, NY (US)

(73) Assignee: InterDigital Patent Holdings, Inc., Wilmington, DE (US)

(21) Appl. No.: 18/854,256

(22) PCT Filed: Apr. 5, 2023
(86) PCT No.: PCT/US2023/017588

§ 371 Date: Oct. 4, 2024

Related U.S. Application Data
(60) Provisional application No. 63/327,640, filed on Apr. 5, 2022.
(60) Provisional application No. 63/395,393, filed on Aug. 5, 2022.
(60) Provisional application No. 63/421,863, filed on Nov. 2, 2022.

(51) Int. Cl. H04W 72/0453; H04L 27/26; H04W 72/1268

(52) U.S. Cl. CPC H04W 72/0453; H04L 27/2601; H04W 72/1268

(57) ABSTRACT

Systems, methods, and instrumentalities are described herein for adaptive waveform selection for wireless communication. In examples, the wireless transmit/receive unit (WTRU) may be configured with the orthogonal frequency-division multiplexing (OFDM) initially. If the WTRU, which may support dynamic waveform switch, receives system information blocks (SIBs) from multiple cells where at least one of them supports dynamic waveform switch, the WTRU may prioritize the initial access with the cell(s) that support dynamic waveform switch. If the WTRU supports dynamic waveform switch, the WTRU may send a physical uplink shared channel (RUSCH) in msg3 at a configured grant, which may be offset by a preconfigured number of slots with a waveform that is different from the preconfigured waveform type.

### CROSS-REFERENCE TO RELATED APPLICATIONS

This application claims the benefit of Provisional U.S. Patent Application No. 63/327,640, filed Apr. 5, 2022, Provisional U.S. Patent Application No. 63/395,395, filed Aug. 5, 2022, and Provisional U.S. Patent Application No. 63/421,863, filed Nov. 2, 2022, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for adaptive waveform selection for wireless communication.

A WTRU may receive a first message from one or more cell(s) (e.g., from a first cell). The first message may indicate whether cell(s) (e.g., neighboring cell(s) support dynamic waveform switching (e.g., may indicate whether a second cell of the neighboring cell(s) supports dynamic waveform switching). The first message may be received via a radio resource control (RRC) transmission or a system information block (SIB) transmission.

The WTRU may select a cell (e.g., the second cell) based on the cell supporting dynamic waveform switching. The WTRU may select the cell (e.g., the second cell) based on (e.g., additionally based on) a measurement (e.g., a reference signal received power (RSRP)) of the cell (e.g., the second cell) being below a threshold. The WTRU may be configured to transmit a preamble to a cell indicated by the first message (e.g., to the second cell). The preamble transmission may indicate a capability of the WTRU to support dynamic waveform switching. In examples, the preamble transmission may indicate the capability of the WTRU to support dynamic waveform switching via one of: a resource used for the preamble transmission, a preamble sequence, or a transmission occasion used for the preamble transmission.

The WTRU may be configured to prioritize one cell (e.g., the second cell) over another cell (e.g., a third cell) of the cell(s) (e.g., the neighboring cell(s)) indicated by the first message). The WTRU may prioritize a cell (e.g., the second cell) that supports dynamic waveform switching over another cell (e.g., a third cell) that does not support dynamic waveform switching (e.g., if the respective measurements of each of the second cell and the third cell are below a threshold).

The WTRU may receive a second message. The second message may be received from the second cell. The second message may indicate a waveform type (e.g., a second waveform type) to use for transmitting a third message. The WTRU may transmit the third message to the second cell (e.g., via a physical uplink shared channel (PUSCH) using the indicated second waveform type. The second waveform type may be a direct fourier transform spread orthogonal frequency-division multiplexing (DFT-s-OFDM) waveform type. The second waveform type (e.g., DFT-s-OFDM waveform type) used to transmit the third message may be switched from a first waveform type (e.g., a cyclic prefix orthogonal frequency-division multiplexing (CP-OFDM) waveform type) used to receive the first message and used to (e.g., additionally used to) communicate with the first cell prior to receiving the first message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of reception of a scheduling PDCCH by the WTRU and corresponding PUSCH.

FIG. 3 illustrates an example of reception of waveform change indication and WTRU behavior.

FIG. 4 illustrates an example PUSCH transmission after the waveform switch.

FIG. 5 illustrates an example of reception of waveform change indication and WTRU behavior.

FIG. 6 illustrates an example of WTRU behavior if scheduled repetitions overlap with the switch window.

FIG. 7 illustrates an example of WTRU behavior if scheduled repetitions overlap with the switch window and the cancellation of repetition(s).

FIG. 8 illustrates an example of WTRU behavior if the waveform is switched in the middle of the repetition of a PUSCH.

FIG. 9 illustrates an example of WTRU behavior if the waveform is switched in the middle of the repetition of PUSCH and the cancellation of transmission(s).

FIGS. 10-11 illustrate examples of waveform switch and joint channel estimation.

FIG. 12 illustrates an example of receiving waveform change indication prior to time window configuration for joint channel estimation.

FIG. 13 illustrates an example of receiving waveform change indication after the time window configuration for joint channel estimation.

FIG. 14 illustrates an example of a 4-step initial access random access channel (RACH) procedure.

FIG. 15 illustrates an example of a 2-step initial access RACH procedure.

FIGS. 16-17 illustrate examples of association between RACH occasions (Ros) and waveforms.

FIG. 18 illustrates an example of dynamic waveform switching.

### DETAILED DESCRIPTION

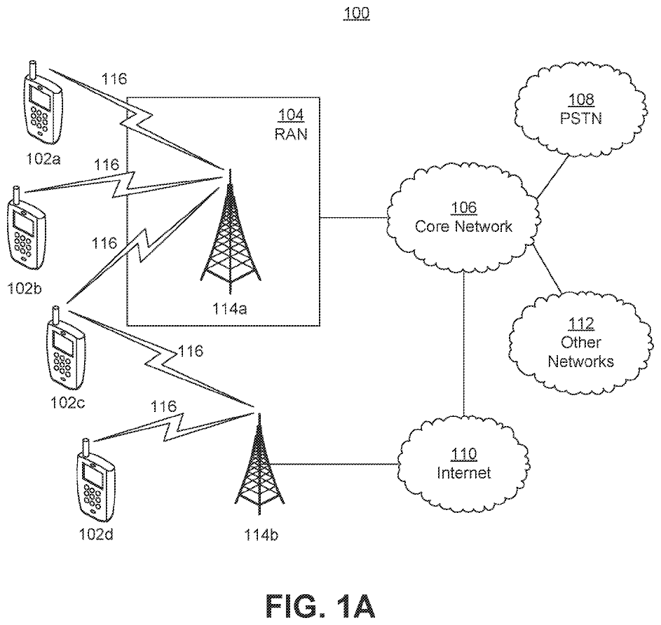

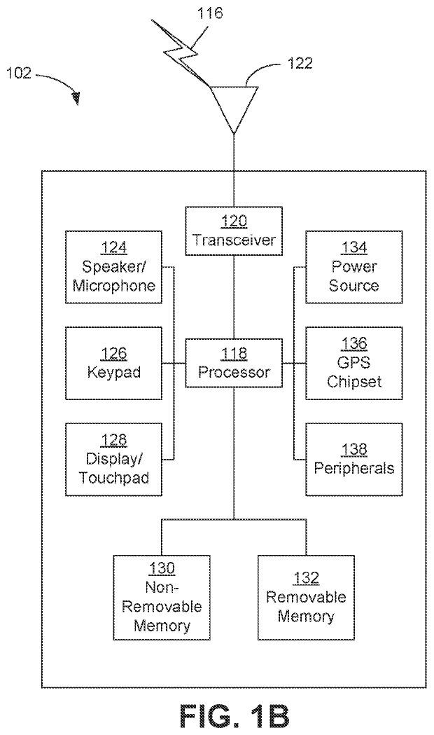

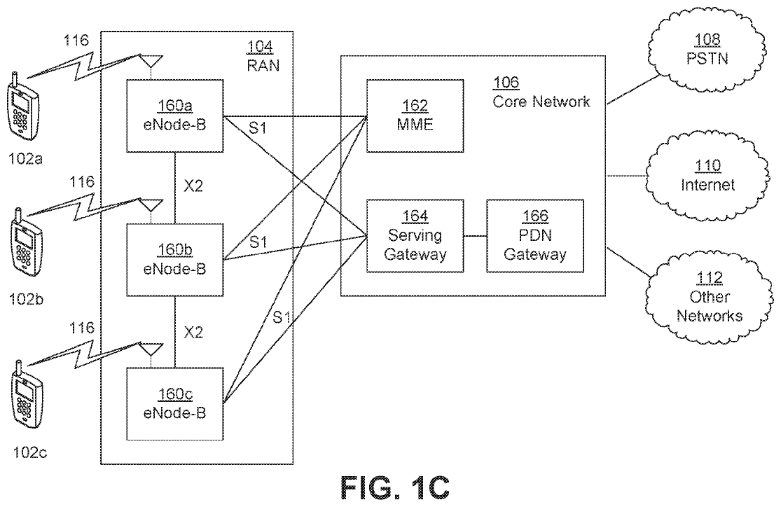

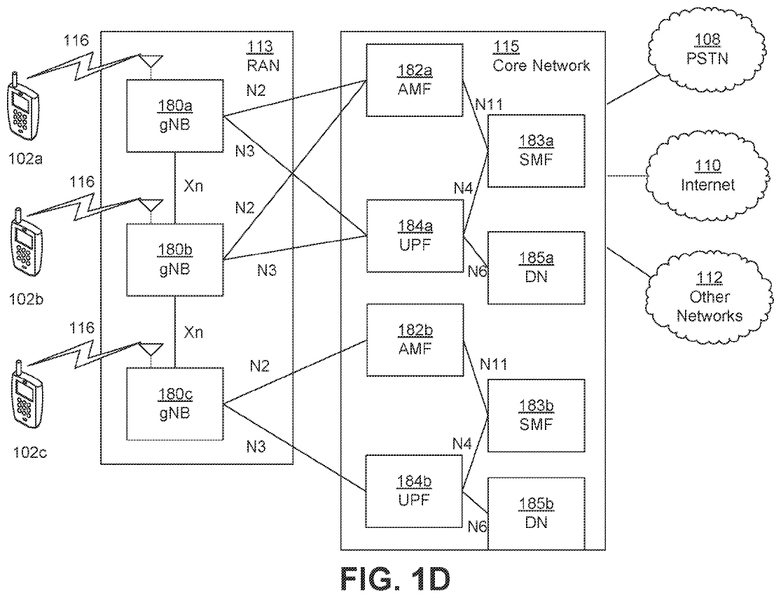

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein for adaptive waveform selection for wireless communication.

A WTRU may receive a first message from one or more cell(s) (e.g., from a first cell). The first message may indicate whether cell(s) (e.g., neighboring cell(s) support dynamic waveform switching (e.g., may indicate whether a second cell of the neighboring cell(s) supports dynamic waveform switching). The first message may be received via a radio resource control (RRC) transmission or a system information block (SIB) transmission.

The WTRU may select a cell (e.g., the second cell) based on the cell supporting dynamic waveform switching. The WTRU may select the cell (e.g., the second cell) based on (e.g., additionally based on) a measurement (e.g., a reference signal received power (RSRP) of the cell (e.g., the second cell) being below a threshold. The WTRU may be configured to transmit a preamble to a cell indicated by the first message (e.g., to the second cell). The preamble transmission may indicate a capability of the WTRU to support dynamic waveform switching. In examples, the preamble transmission may indicate the capability of the WTRU to support dynamic waveform switching via one of: a resource used for the preamble transmission, a preamble sequence, or a transmission occasion used for the preamble transmission.

The WTRU may be configured to prioritize one cell (e.g., the second cell) over another cell (e.g., a third cell) of the cell(s) (e.g., the neighboring cell(s) indicated by the first message). The WTRU may prioritize a cell (e.g., the second cell) that supports dynamic waveform switching over another cell (e.g., a third cell) that does not support dynamic waveform switching (e.g., if the respective measurements of each of the second cell and the third cell are below a threshold). In examples, prioritizing the second cell that supports dynamic waveform switching may enable a switch to a DFT-s-OFDM waveform (e.g., which may provide increased throughput).

The WTRU may receive a second message. The second message may be received from the second cell. The second message may indicate a waveform type (e.g., a second waveform type) to use for transmitting a third message. The WTRU may transmit the third message to the second cell (e.g., via a physical uplink shared channel (PUSCH) using the indicated second waveform type. The second waveform type may be a direct fourier transform spread orthogonal frequency-division multiplexing (DFT-s-OFDM) waveform type. The second waveform type (e.g., DFT-s-OFDM waveform type) used to transmit the third message may be switched from a first waveform type (e.g., a cyclic prefix orthogonal frequency-division multiplexing (CP-OFDM) waveform type) used to receive the first message and used to (e.g., additionally used to) communicate with the first cell prior to receiving the first message.

In examples, waveforms for uplink transmission may be configured semi-statically. The waveform the WTRU may use for uplink transmission may be broadcasted by the network (e.g., gNB) (e.g., during the initial access). In examples, the WTRU may either use DFT-s-OFDM or OFDM for uplink transmission. In examples herein, an OFDM waveform type may be a CP-OFDM waveform type. While OFDM may be compatible with a single input single output (SISO) or multiple input multiple output (MIMO) transmission, DFT-s-OFDM may be (e.g., may be only) compatible with SISO transmission (e.g., in NR). In terms of PAPR performance, due to DFT-spreading before OFDM modulation, DFT-s-OFDM may exhibit lower PAPR than OFDM, which may be suitable for coverage-limited scenarios where high transmission power may be required for uplink transmission. There may be a tradeoff between OFDM and DFT-s-OFDM (e.g., a tradeoff between throughput and coverage performance).

For UL transmission, UL transmission power may be limited, making optimum selection of a waveform important for maximizing coverage or throughput. In examples, for the WTRU located in the proximity of the gNB, OFDM with MIMO may be configured. For the WTRU located far away from the gNB, DFT-s-OFDM with SISO may be configured. In examples, the WTRU may be signaled to switch waveforms. In examples (e.g., in coverage limited scenarios), signaling from the network to switch waveforms may introduce signaling overhead (e.g., especially when the WTRU moves back and forth frequently). In examples (e.g., additionally, during the initial access), signaling from the network to switch waveforms may not be available at the gNB without establishing initial connection with the WTRU. Timely signaling may be required to achieve communication (e.g., seamless communication).

A transmission using a DFT-s-OFDM waveform may be equivalent to a transmission with transform precoding enabled. A transmission using a OFDM or a CP-OFDM waveform may be equivalent to a transmission with transform precoding disabled.

Examples of transmissions of multi-PHRs to assist switching waveforms may be provided herein. In examples, the WTRU may be preconfigured with a first waveform type (e.g., OFDM, DFT-s-OFDM). The WTRU may be preconfigured with one or more conditions that may trigger the WTRU to send more than one power headroom reports (PHRs) (e.g., two) to the network (e.g., gNB). The second waveform type (e.g., OFDM, DFT-s-OFDM) may be a different or same waveform as the first waveform. In examples, the WTRU may be configured with an OFDM waveform type via an RRC as the first waveform type. If a condition is satisfied (e.g., change in RSRP in CSI-RS is above the threshold), the WTRU may return multiple PHRs (e.g., two PHRs, one for OFDM and another PHR for DFT-s-OFDM).

The WTRU may be preconfigured with more than two waveform types (e.g., waveform type(s) in addition to DFT-s-OFDM and OFDM). The WTRU may be configured with waveform types that are at least: different from OFDM and DFT-s-OFDM (e.g., single carrier waveform types), Frequency Shift Keying (FSK), a combination of DFT-s-OFDM and OFDM, or variations of DFT-s-OFDM or OFDM. The WTRU may be provided with an ID for a waveform type (e.g., each waveform type). An association between IDs and waveforms may be provided by the network in RRC, MAC-CE or DCI. The WTRU may determine which waveform type to use for UL transmission based on the indicated ID in MAC-CE or DCI. If the WTRU is preconfigured with more than two waveform types, the WTRU may receive a configuration for at least: the default waveform semi-statically (e.g., RRC), by broadcast (e.g., SIB), or dedicated signaling.

The PHR calculation for the second (e.g., non-configured) waveform(s) may be based on the resources (e.g., number of symbols/slots/frames/RBs) allocated for the first waveform. The WTRU may be preconfigured with multiple waveform types (e.g., two waveform types, which may be a DFT-s-OFDM waveform type and OFDM waveform type, for example a DFT-s-OFDM waveform type and a CP-OFDM waveform type as described herein.) The WTRU may be configured to use OFDM (e.g., CP-OFDM waveform type) for UL first. If a triggering condition (e.g., a measurement (e.g., RSRP) of a CSI-RS is below the preconfigured threshold) to send PHRs for the waveform types (e.g., both waveform types) is satisfied, the WTRU may determine to compute PHR for DFT-s-OFDM based on the resources allocated for an OFDM waveform type (e.g., CP-OFDM waveform type). The WTRU may compute PHR for an OFDM waveform type (e.g., CP-OFDM waveform type). The WTRU may send (e.g., subsequently send) PHRs (e.g., both PHRs) to the network.

PUCCH and PUSCH may be used interchangeably herein. Waveform and waveform type may be used interchangeably herein.

The PHR may deliver the power headroom and the real Pcmax that may be calibrated in the WTRU for a defined UL grant. Flags/indicators (e.g., other flags/indicators) may (e.g., may also) be present for P-MPR that signal a SAR or MPE situation.

The PHR may have an important effect on the Base Station (BS) scheduler. The BS scheduler may have knowledge (e.g., initial knowledge) of maximum power reduction (MPR) and A-MPR tables. The values in the tables may represent the maximum power reductions allowed for a WTRU. As the WTRUs may have different implementations, the calibrated values may be better than the listed power reductions. As the PHR and Pcmax,c may be representing the real values from a WTRU, the BS scheduler may learn the WTRU capabilities in terms of power reduction, converging to an optimized scheduling process. The MPR differences between the considered waveform types (e.g., CP-OFDM and DFT-s-OFDM) may be in the order 2 dB or even higher depending on frequency rage (FR1 or FR2) and modulation.

The PHR calculation may be called real (e.g., real PHR) when it is based on an UL grant. The UL grant may include an RB allocation and a Modulation and Coding Scheme (MCS). Based on the RB allocation and modulation, the WTRU may determine the Pcmax,c for the Component Carrier (CC) which is the maximum configured power that the WTRU may use under the current UL grant conditions. The allocated power in the physical layer may be required to be less than or equal with the determined Pcmax,c. If the allocated power in physical layer exceeds the determined Pcmax,c, the WTRU may be required to scale down its allocated power (e.g., initially allocated power) until the Pcmax,c limit is respected. The Pcmax,c in a CC may consider the MPR requirements, the A-MPR (additional MPR which may be related to geographical protections for bands or other wireless services), and other insertion losses due to RF front end architecture. A power reduction may be related to SAR or maximum permissible exposure (MPE) limits in the form of P-MPR. This reduction may be triggered by proximity of human body detection by WTRU sensors. The P-MPR may affect waveforms (e.g., both waveforms) equally (e.g., in examples provided herein).

Pcmax,c may be the maximum configured power for a CC. Pcmax,c may be a function of MPR, A-MPR, PpowerClass, Pemax (WTRU maximum power for the cell, signaled by SIBs), P-MPR, and other insertion losses of the RF frontend Delta Tc, Delata Tib. P-MPR may be the power management reduction. This may be applied when body proximity is detected by WTRU sensors for SAR (FR1) and MPE (FR2). If applied, the P-MPR may be signaled by a flag in the PHR. Spectrum Absorption Rate (SAR) may be a compliance limit of the electromagnetic radiation per volume of human tissue (e.g., specific for FR1). MPE may be a compliance limit of the electromagnetic radiation per surface area of the human body (e.g., specific to FR2).

The MPR, A-MPR, P-MPR may be intra-band contiguous or inter-band in the carrier aggregation case. For intra-band contiguous, the MPR may be common for the entire bandwidth. For inter-band, the MPR may be per band/CC (as the CCs are in different bands). The MPR, A-MPR, P-MPR may be applied per CG or per bad in the dual connectivity case.

Examples of conditions for the WTRU to transmit multiple PHRs may be provided. In examples, the WTRU may be preconfigured with conditions that trigger the WTRU to send more than one PHR (e.g., a dual-PHR, a PHR corresponding to each waveform, two PHRs corresponding to the first and second waveform) to the network if at least one of the following conditions is satisfied: a change in RSRP compared to the last occasion the WTRU measured DL RS (e.g., CSI-RS, DM-RS) or SSB is above the preconfigured threshold for a certain amount of time measured in time units, or slots/frames; a RSRP of DL-RS or SSB is below or above the preconfigured threshold; a MPE is above the preconfigured threshold; the amount of data in BSR is above or below the preconfigured threshold and the condition for Dual-PHR are met; the WTRU receives an indication from the network to report more than one PHRs or PHR for a specific waveform PHR-O or PHR-D; the PHR of the current waveform is below XdB (e.g., X may be a configurable threshold as 0, 2, 3, or 4 dB); or the calculated PHR difference between the current waveform and another waveform for at least one serving cell is or becomes higher than XdB, where X can be a network configurable or fixed value.

For the condition of the change in RSRP compared to the last occasion the WTRU measured a DL RS (e.g., CSI-RS, DM-RS) or the SSB being above the preconfigured threshold for a certain amount of time measured in time units, or slots/flows, a prohibit timer may be configured by network to avoid flooding the network with multiple reports.

For the condition of the RSRP of a DL-RS or the SSB being below or above the preconfigured threshold, if the RSRP of CSI-RS is below the preconfigured threshold, the WTRU may determine to send PHR for preconfigured waveform(s) (e.g., each preconfigured waveform). The condition may be required to persist for a certain amount of time measure in time units, or slots/frames to trigger a PHR. A prohibit timer may be configured by network to avoid flooding the network with multiple reports.

Examples associated with the thresholds (e.g., preconfigured thresholds) described herein are provided. The threshold(s) herein may be signaled by MAC, configured by RRC, or indicated in the DCI. The thresholds or the conditions described herein may be broadcasted or sent by dedicated signaling by the network (e.g., in a SIB). Based on the broadcasted information or dedicated signaling, the WTRU may determine to send PHR(s) for preconfigured waveforms or waveforms configured in broadcast information (e.g., via a SIB), via dedicated signaling in msg3, msg5 and/or msgA during the initial access.

Examples of the WTRU sending PHR(s) to the network may be provided. If a condition (e.g., one the above conditions is satisfied), the WTRU may determine to transmit PHR(s) to the network. The WTRU may include PHR(s) in scheduled PUSCH or PUCCH. The WTRU may determine to include (e.g., in both) PUCCH and PUSCH if the size of PHR(s) exceed the limit of PUSCH or PUCCH.

The Dual-PHR may take the form of a physical layer flag/indication if a computed Dual-PHR condition configured by network is met. In examples, if the Dual-PHR calculation shows a power limited situation and the delta PHR between the waveforms on the current UL grant is higher than XdB, the Dual-PHR may take the form of a physical layer flag/indication if a computed Dual-PHR condition configured by network is met. This indication may be sent by UCI within a PUSCH or PUCCH.

Examples of enhanced PHR format for multiple waveforms may be provided herein. The WTRU may be configured to transmit a PHR report according to a new format (e.g., MAC CE) if dynamic waveform switching is configured for at least one serving cell. The report may include an indication of whether PHR information on at least one waveform type is included for serving cells (e.g., for each serving cell or for all serving cells). The PHR information for a waveform type may be expressed in terms of a difference with respect to a reference waveform type. The reference waveform type may be the waveform type used for the PUSCH (or SRS) for an actual PHR or a waveform type configured for a reference format for a virtual PHR. If the WTRU prepares a PHR, the WTRU may include PHR information for a different waveform type than the reference waveform type for a serving cell on a condition (e.g., only on a condition) that the difference is higher than a threshold. The threshold may be pre-defined or configured by higher layers.

Examples of correspondence between PHR and MCS/waveform are provided herein. The WTRU may be preconfigured to send more than one PHR where PHRs (e.g., each PHR) may correspond to a different waveform type. In examples, multiple PHRs may correspond to different MCS for the same waveform type. In examples, the WTRU may be preconfigured to send more than one PHRs where PHRs (e.g., each PHR) may correspond to different MCS (e.g., QPSK, 16 QAM) for the same waveform (e.g., OFDM, DFT-s-OFDM).

In examples, the WTRU may be preconfigured to send a PHR for preconfigured waveforms (e.g., each preconfigured waveform) if a condition (e.g., one of the aforementioned conditions) is satisfied. The WTRU may be indicated by the network to send a PHR for the indicated waveform if a condition (e.g., one of the aforementioned conditions) is satisfied. In examples, the WTRU may be preconfigured to send a PHR for DFT-s-OFDM if a condition is satisfied. If the RSPR of CSI-RS is below the preconfigured threshold, the WTRU may determine to send a PHR for DFT-s-OFDM.

The Dual-PHR may be computed for the PHR for the current waveform type and add a delta (difference) for the second waveform type on the same UL grant. The delta value may be a quantified value in the form of a look up table (LUT) or simply a flag/indicator, indicating that a different waveform type (e.g., the one not in current use) has a PHR better than a certain value (e.g., better than 2 dB).

The PHR triggered for waveform switching may be presented into a different format if triggered. For example, when the Dual-PHR is triggered, a specific flag for Dual-PHR may sent and (e.g., and then) just the waveform related PHR may be sent. The WTRU may send the real PHR (e.g., real alternate PHR) using the current mapping.

Examples of PHRs using assumptions for allocation within a carrier or spectrum shaping are provided herein. The WTRU may report a PH applicable to a certain waveform under a certain assumption for the PUSCH allocation in the frequency domain. Such a PH may be included in a PHR (e.g., in addition to a PH calculated using another solution or a PH calculated according to legacy). For example, the WTRU may apply at least one of following assumptions even if not satisfied by the actual PUSCH transmission used for the calculation of the PH: the absolute difference between the highest frequency of the carrier and the highest frequency of the PUSCH allocation is lower (or higher) than X resource blocks (RB's); the absolute difference between the lowest frequency of the carrier and the lowest frequency of the PUSCH allocation is lower (or higher) than Y resource blocks (RB's); the PUSCH allocation is an edge allocation, an outer allocation, or an inner allocation; the number of RB's of the PUSCH allocation is lower or higher than a threshold Z; or the PUSCH allocation is contiguous (e.g., possibly with same total number of RB's as the allocation of the actual PUSCH transmission).

At least one assumption and applicable values of X, Y and Z may be pre-defined or signaled by an RRC or a MAC (e.g., as indicated above). Such threshold(s) may be pre-defined or signaled by an RRC or a MAC.

The WTRU may report the upper limit and/or the lower limit of a frequency allocation for the PUSCH such that the difference of the PH or Pcmax between two waveform types is lower than a threshold. The threshold and waveform types may be pre-defined or signaled by a RRC or a MAC. The WTRU may perform this reporting if requested from the network (e.g., such as indicated in a MAC CE or DCI). The lower and upper limits may be expressed in terms of RB indices within the carrier or in terms of a number of RBs between the applicable limit and the upper or lower edge of the carrier. In examples (e.g., in the latter case), the WTRU may report two values X and Y, where X may correspond to the number of RBs between upper edge of allocation and the upper edge of carrier and Y may correspond to the number of RBs between the lower edge of allocation and the lower edge of carrier. In examples, the WTRU may report a single value for both.

The WTRU may report a PH under an assumption that a spectrum shaping technique such as frequency-domain spectrum shaping or peak reduction tone reservation is used. The WTRU may report this PH under a condition that the actual PUSCH transmission satisfies certain conditions. In examples, the condition may be that the waveform type used for the actual PUSCH transmission is a DFT-S-OFDM waveform type.

The WTRU may trigger a report including at least one additional PH (e.g., of the above PH additional PHs) or include an additional PH in a PHR under a condition that the PH applicable to the actual transmission becomes lower than (or higher than) a threshold or is lower than (or higher than) a threshold. The threshold may be pre-defined or signaled by a MAC or a RRC.

Examples of L1 indications if the PH difference between waveforms is above a threshold are provided herein. The WTRU may transmit an indication at L1 such as a PUCCH or uplink control information if a condition related to a power headroom is met (e.g., which may have the benefit of quickly informing the network if a change of waveform is appropriate).

The L1 indication may be transmitted using a scheduling request resource configured for this purpose using RRC signaling. The WTRU may follow the same procedure as for the transmission of a scheduling request, except that cancellation of a pending SR would occur under a condition that a PHR or enhanced PHR is included in a PUSCH transmission or under a condition that a PUSCH is transmitted using a certain waveform type (e.g., a DFT-S-OFDM waveform type).

The conditions for triggering transmission of the indication may include at least one of the following: the WTRU last transmitted a PUSCH using a certain waveform (e.g., a CP-OFDM waveform); the PH of the last transmitted PUSCH is below a threshold; the difference of a PH or a Pcmax between a PUSCH assumed to be transmitted under a first waveform type (e.g., a CP-OFDM waveform type) and a PUSCH assumed to be transmitted under a second waveform type (e.g., a DFT-S-OFDM waveform type) is higher than a threshold; or a path loss estimate is higher than a threshold or path loss estimate has changed by more than a threshold since the last transmission of the L1 indication or of a PHR.

At least one trigger (e.g., of the above triggers) may (e.g., may also) be used for the transmission of an enhanced PHR for multiple waveform types.

Examples of Carrier Aggregation (CA) and Dual Connectivity (DC) scenarios may be provided. For an intra-band case, a Dual-PHR in a CC may trigger Dual-PHRs on CCs (e.g., all CCs). A Dual-PHR triggered in one CC may be considered in the CC (e.g., only in the CC) that triggered the Dual-PHR, while the other PHR report may be based on legacy format. The Dual-PHR may be a configurable report per CC or Cell Group (CG). For the intra-band cases where dual Power Amplifier (PA) may be reported by the WTRU, per CC or CG Dual-PHR may be configurable as well.

For inter-band cases, the Timing Advance Group (TAG) may be defined. For inter-band, a triggered Dual-PHR may be limited to CCs (e.g., active CCs) within a band, a TAG or CG. A full Dual-PHR may be triggered for (e.g., both) bands and may be a network configured report.

Examples of responses from the network for multiple PHRs may be provided. Indications associated with grant type or PUSCH may be provided. In examples, the WTRU may receive a DCI or a MAC-CE, which may include an indicator of which waveform to use. The WTRU may receive the indicator if the WTRU sends the PHR(s) to the network. The indicator may be associated with a grant or scheduled PUSCH. In examples, the WTRU may receive the indication of the waveform associated with a configured grant (e.g., configured grant type 1 or 2, dynamic grant). In examples, the WTRU may receive a scheduling DCI associated with a PUSCH the WTRU transmits. The DCI may include the waveform the WTRU may use for the associated PUSCH.

The network may send the waveform switching order to a WTRU without any PHR or Dual-PHR or (e.g., other) triggered indication from the WTRU. This may be linked to a situation where the WTRU is using a DFT-s-OFDM waveform by default, is in good coverage (e.g., good UL SNR), and the Buffer Status Report (BSR) indicates a good amount of data for UL and UL MIMO may be a solution to increase the UL throughput.

Examples of securely receiving the waveform switch command from the network are provided herein. In examples, the WTRU may receive an indication to switch a waveform type in a PDCCH (e.g., dedicated PDCCH). In examples, the PDCCH may include information about which waveform and MCS the WTRU may use for uplink transmission. Such indication may reduce a risk of misdetection at the WTRU.

In examples, the WTRU may be scheduled with an occasion (e.g., slot #, symbol #, dynamic/configured grant) at which the WTRU may expect to receive an indication (e.g., via PDCCH/PDSCH), about which waveform type the WTRU should use for UL transmission. If the WTRU does not receive the indication from the network, the WTRU may continue to use the current waveform type. In examples, the WTRU may be configured to use OFDM. The WTRU may receive an indication from the network that the PDCCH (e.g., the next PDCCH) the WTRU receives may include an indication to switch to DFT-s-OFDM. If the WTRU receives PDCCH and the WTRU does not find the indication to switch the waveform, the WTRU may determine to use OFDM for UL transmission.

Examples of indications in the form of negative ACK (NACK) or indications (e.g., implicit indications) for retransmission after PHR(s) are sent are provided herein. The WTRU may determine to switch the waveform type (e.g., if receiving a command to retransmit PUSCH(s) or PUCCH(s) or if the WTRU sends PHR(s) (e.g., Dual-PHR) to the network). In examples, if the WTRU is configured with OFDM, the WTRU may send PHRs for OFDM and DFT-s-OFDM if one or more conditions (e.g., of the aforementioned conditions) are satisfied. If the PHRs (e.g., after the PHRs) are sent to the network, and if the WTRU determines explicitly (e.g., a command sent from the network) or implicitly (e.g., ACK from the network for the transmitted PUSCH is not received) to retransmit PUSCH(s), the WTRU may determine to switch to DFT-s-OFDM for retransmission.

For the CA or DC case, a waveform switch indication order may apply to CCs (e.g., to the CCs in the same CG), TAG, or on CCs (e.g., all CCs) across active CCs in bands (e.g., all bands). This waveform switch indication may have information (e.g., additional information) about the CCs to be applied. In the CA or DC cases, the cell may be active or inactive. When a CC is activated, the WTRU may follow at least the following rules for the waveform to be used: automatically use the same waveform as the rest of the CCs in the CG, TAG, or Pcell/PScell; include specific indication(s) in the CC activation for the waveform to be used in the CC; include a CC activation with a wave switch indication (e.g., different than the active waveform with the CG, TAG) that may switch the waveform for the entire CG, TAG; and include a CC deactivation that may be bundled with a waveform switching (e.g., as more power may be available for the WTRU).

In examples, the WTRU may be configured with a first or default waveform type (e.g., OFDM) via an RRC. The WTRU may send its capability information (e.g., dynamic waveform switching). The WTRU may be configured with a code rate table. The code rate table may include code rates for waveform types (e.g., two waveform types) and corresponding modulation and coding rate(s). The WTRU may measure if a DL-RS (e.g., CSI-RS) and a change in RSRP (e.g., compared to the last measurement occasion) is above a preconfigured threshold. If the WTRU is scheduled with a dynamic grant, the WTRU may determine to send PHRs (e.g., two PHRs) to the network (e.g., one for the first waveform type (e.g., OFDM) and another PHR for a second waveform type (e.g., DFTsOFDM)). The PHR may be computed based on the resources scheduled for the first waveform type. If the WTRU is not scheduled with a dynamic grant, the WTRU may return the PHR for the first waveform type. The WTRU may determine the waveform for the remaining UL transmission in the grant. If the WTRU receives a configuration for a waveform type via DCI from the network, the WTRU may determine to switch the waveform type at the next transmission occasion. Otherwise (e.g., if the WTRU does not receive a configuration for a waveform type via DCI from the network), the WTRU may complete UL transmission in the grant with the first waveform type.

Examples of WTRU behavior if receiving (e.g., after receiving) waveform switch indication(s) from the network are provided herein. Examples of ACK/NACK for switching waveforms are provided herein. The BS and the WTRU may agree on what waveform type is used by the WTRU for UL transmissions. This may be called waveform state synchronization. A change in waveform usage may be acknowledged if ordered (e.g., after ordered) by the network. The network waveform switch order may come through MAC, RRC, or DCI indications.

The WTRU may send an ACK to the network (e.g., gNB) if the WTRU receives and/or correctly decodes the indication(s) from the network via DCI or MAC-CE to switch the waveform type or use the indicated waveform type. The WTRU may determine to switch to the indicated waveform type if the WTRU transmits the ACK to the network.

For the CA and DC cases where the scheduling goes per CC, the WTRU may switch waveform if acknowledging (e.g., only after acknowledging) the waveform switching order from the BS and (e.g., and then) activating the second waveform type at the time that may be at least defined as follows: the waveform switch activation time may be indicated by the network in slots/frames by an RRC configuration or dynamically with the waveform switch order; the waveform activation time may be set for the next UL grant on a CC (e.g., any CC) after the switch order Ack is validated; or if the waveform switch indication is bundled with a CC activation order, then the waveform switch time may be after the CC activation specified delay and set for the next valid UL grant in the CC.

Examples of time windows for switching waveforms are provided herein. In examples, the WTRU may require a preconfigured time window to switch the waveform type. The duration of the time window may depend on WTRU capability on how fast the WTRU can switch the waveform type. The time window may start a certain time (e.g., one symbol, N symbols, one slot, M slots, one frame, K frames) after the PDCCH or PDSCH, which may include the indication to switch the waveform type. The details of the time window (e.g., duration, start/end time) may be included in RRC or indicated in DCI or MAC-CE. The duration of window may be configured semi-statically (e.g., via RRCs) or dynamically (e.g., via DCI, MAC-CE).

Examples of WTRU behavior if receiving the waveform switching command after being scheduled with an UL transmission are provided herein. Examples of WTRU behavior if the waveform switching indication is received after scheduling PDCCH are provided. In examples, the WTRU may determine to transmit a PUSCH after switching the waveform type based on at least one of the following criteria: whether the PUSCH is scheduled before the WTRU received an indicator via a PDCCH/PDSCH from the network; whether the scheduled PUSCH overlaps with the time window during which the WTRU is switching the waveform is expected to switch the waveform; or WTRU capability (e.g., whether the WTRU can transmit the PUSCH where the corresponding scheduling PDCCH/PDSCH is received before waveform change indication).

In examples (e.g., during the window), the WTRU may not transmit a PUSCH or PUCCH, so the WTRU may switch the waveform type. The WTRU may transmit a PUSCH or PUCCH during the time window but use the previous configured waveform type. In examples, if the WTRU is currently configured with OFDM, and the WTRU receives an indication from the network to switch to DFT-s-OFDM, the WTRU may use OFDM to transmit PUSCH or PUCCH during the time window. The WTRU may use DFT-s-OFDM to transmit PUSCH or PUCCH (e.g., after the time window).

Depending on capability, the WTRU may not be able to process scheduling PDCCH or PDSCH during the time window. The WTRU may not be expected to transmit PUSCH or PUCCH scheduled by PDCCH or PDSCH received during the time window. Depending on capability, the WTRU may be expected to process scheduling PDSCH or PDCCH received during the time window so that the WTRU can send the scheduled PUSCH or PUCCH after the waveform type is switched (e.g., after the end of the time window). In examples, the WTRU may drop a scheduled PUSCH or PUCCH which was scheduled prior to receiving the indication to switch the time window.

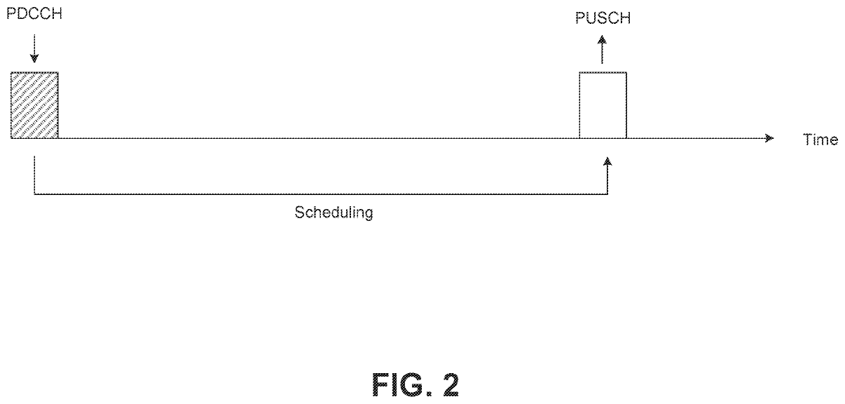

FIG. 2 illustrates an example of reception of a scheduling PDCCH by the WTRU and a corresponding PUSCH. In FIG. 2, a scheduling PDCCH and a corresponding PUSCH is shown where the PDCCH may include the timing at which the WTRU may transmit a PUSCH.

The WTRU may determine to cancel a PUSCH transmission which is scheduled prior to the waveform change if at least one of the following conditions is satisfied: the WTRU is not capable of transmitting PUSCH which is scheduled with a different waveform type; the resources (e.g., number of symbols, slots, RBs, REs) of the scheduled PUSCH are different between different waveform types (e.g., PUSCH occupies different time/frequency resources for OFDM and DFT-s-OFDM); or parameters (e.g., MCS) for the scheduled PUSCH are not supported by the switched waveform type. If PUSCH is scheduled assuming pi/2 BPSK for DFT-s-OFDM and the WTRU is indicated to switch to OFDM, the WTRU may determine to cancel the scheduled PUSCH transmission since pi./2 BPSK may not be supported by OFDM).

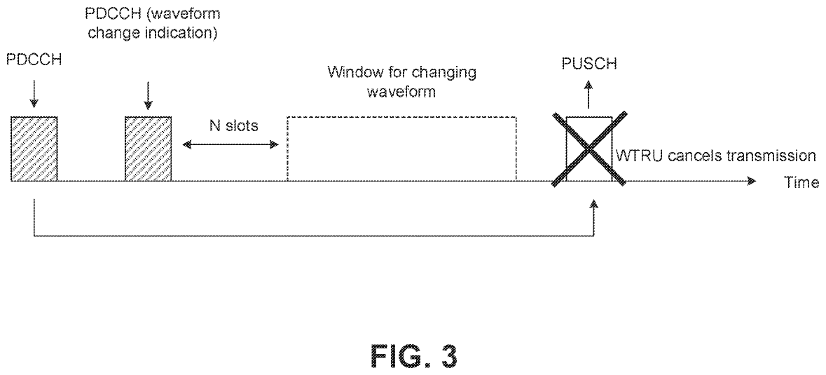

FIG. 3 illustrates an example of reception of waveform change indication and WTRU behavior. In FIG. 3, the WTRU behavior if the WTRU receives waveform change indication after the scheduling PDCCH is shown. If the waveform change indication is received after the scheduling PDCCH, the WTRU may determine to cancel the transmission of the scheduled PUSCH after the WTRU completes the waveform switch (e.g., since the PUSCH is scheduled based on the previously configured waveform). In FIG. 3, the WTRU may initiate the time window to switch the waveform N slots after the reception of PDCCH, which may include the indication to switch the waveform.

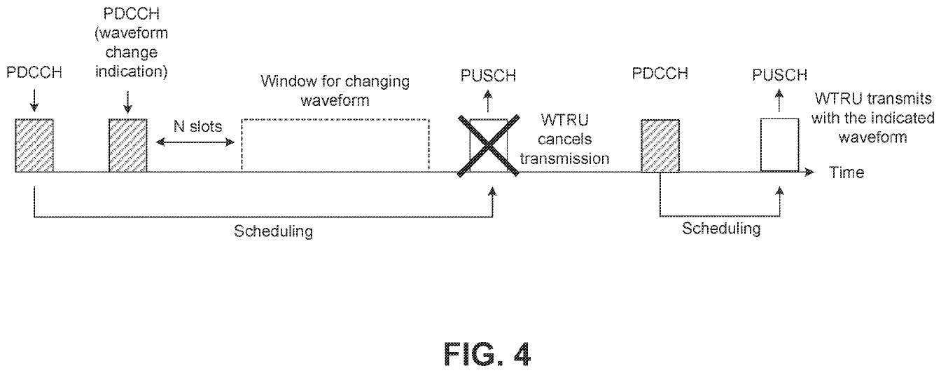

FIG. 4 illustrates an example PUSCH transmission after the waveform switch. As shown in FIG. 4, the WTRU may determine to transmit PUSCH if it is scheduled after the WTRU switches the waveform.

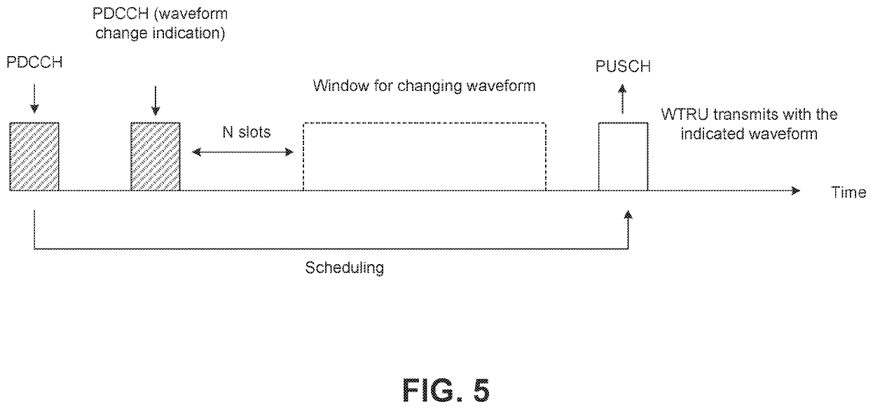

FIG. 5 illustrates an example of reception of waveform change indication and WTRU behavior. In examples, the WTRU may determine to transmit a PUSCH scheduled prior to receiving the waveform change indication. The WTRU may determine to transmit the PUSCH if at least one of the following conditions is satisfied: the WTRU is capable of transmitting PUSCH which is scheduled with a different waveform; the resources (e.g., number of symbols, slots, RBs, resource elements (REs) of the scheduled PUSCH remain the same between different waveforms (e.g., PUSCH occupies the same time/frequency resources for OFDM and DFT-s-OFDM); or parameters (e.g., MCS) for the scheduled PUSCH are supported by the switched waveform.

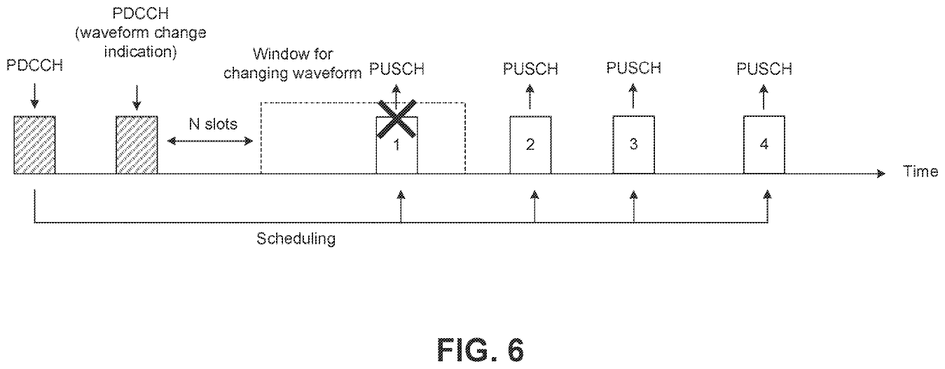

FIG. 6 illustrates an example of WTRU behavior if scheduled repetitions overlap with the switch window. The WTRU may determine to cancel transmission(s) of a PUSCH that overlap with the window for changing the waveform. In examples (e.g., as illustrated in FIG. 6), the WTRU may be scheduled with 4 PUSCH repetitions by the scheduling PDCCH. The first (e.g., only the first) PUSCH in the 4 repetitions may be scheduled by the scheduling PDCCH. The WTRU may determine (e.g., in such a case) when to transmit the rest of the repetitions (e.g., PUSCH#2, #3 and #4 in FIG. 6). If the repetitions are scheduled (e.g., after the repetitions are scheduled), the WTRU may receive a PDCCH indicating to switch the waveform. If the time window overlaps with one of the repetitions (e.g., PUSCH), the WTRU may cancel the transmission of the PUSCH(s) that overlap with the window (e.g., PUSCH #1 in the example illustrated in FIG. 6).

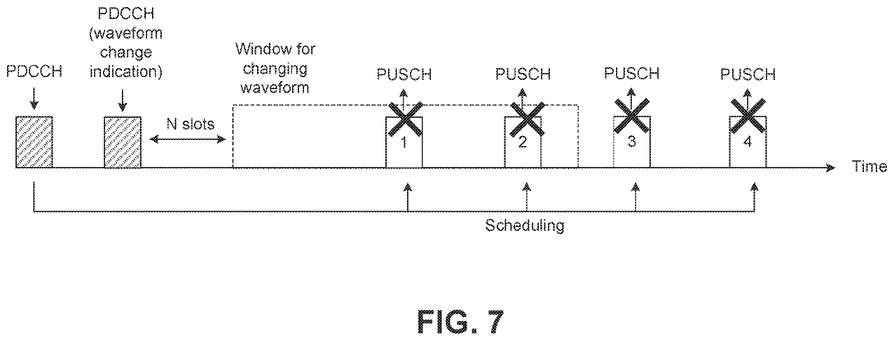

FIG. 7 illustrates an example of WTRU behavior if scheduled repetitions overlap with the switch window and the cancellation of repetition(s). The WTRU may determine to cancel transmission of PUSCH repetitions that overlap with the window for changing the waveform, and PUSCH repetitions which do not overlap with the window (e.g., as illustrated in FIG. 7).

Examples related to UL repetition may include repetition of a PUSCH or PUCCH. The WTRU may determine to switch a waveform type and use the switched waveform type to complete transmission of repetitions. In examples (e.g., as illustrated in FIG. 7), the WTRU may receive an indication to switch the waveform type after the WTRU transmits 2 out of 4 scheduled repetitions. Since the time window for switching the waveform type may not overlap with PUSCH repetition transmission occasions, the WTRU may determine to use the switched waveform type to transmit repetition #3 and #4.

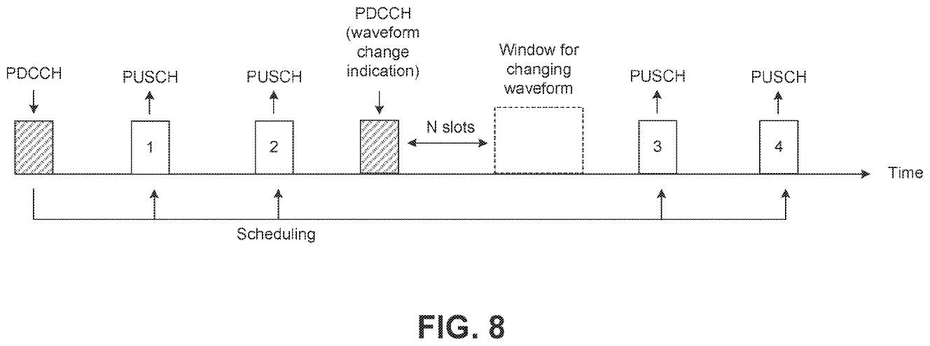

FIG. 8 illustrates an example of WTRU behavior if the waveform is switched in the middle of the repetition of a PUSCH. The WTRU may determine to cancel transmission of repetitions after receiving the command to switch the waveform type. As illustrated in FIG. 8, the WTRU may receive an indication to switch the waveform type after the WTRU transmits 2 out of 4 scheduled repetitions. Even if the time window for switching the waveform type does not overlap with PUSCH repetition transmission occasions, the WTRU may determine to cancel transmission of repetition #3 and #4 with the switched waveform. In examples, the WTRU may be configured to cancel transmission of repetitions if the WTRU receives an indication to switch the waveform type in the middle of repetitions. In examples, whether the WTRU continues to complete transmission after the waveform switch (e.g., as illustrated in FIG. 7), or cancels transmission (e.g., as illustrated in FIG. 8), may depend on the WTRU capability and/or configuration from the network.

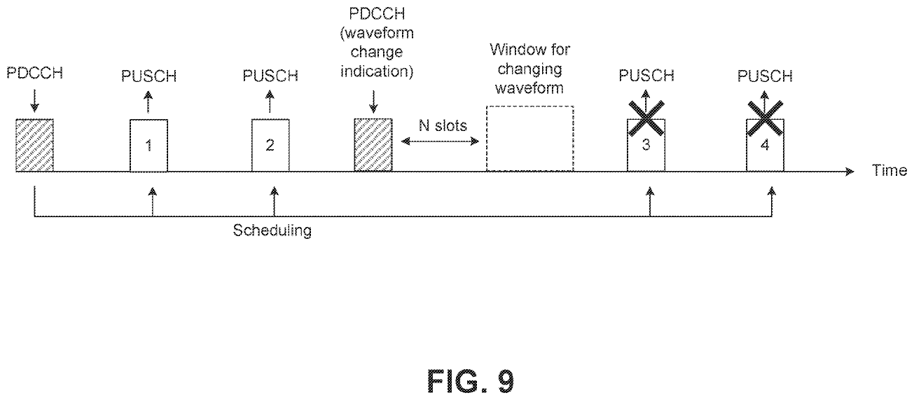

FIG. 9 illustrates an example of WTRU behavior if the waveform is switched in the middle of the repetition of PUSCH and the cancellation of transmission(s). If the WTRU receives DCI or MAC-CE before the WTRU completes PUSCH repetitions, the WTRU may determine to switch to the indicated waveform type before the WTRU completes the PUSCH repetitions.

Examples of WTRU behavior of waveform switch during joint channel estimation may be provided. Timing with respect to scheduled PUSCH for phase/power continuity/consistency maintenance may be provided.

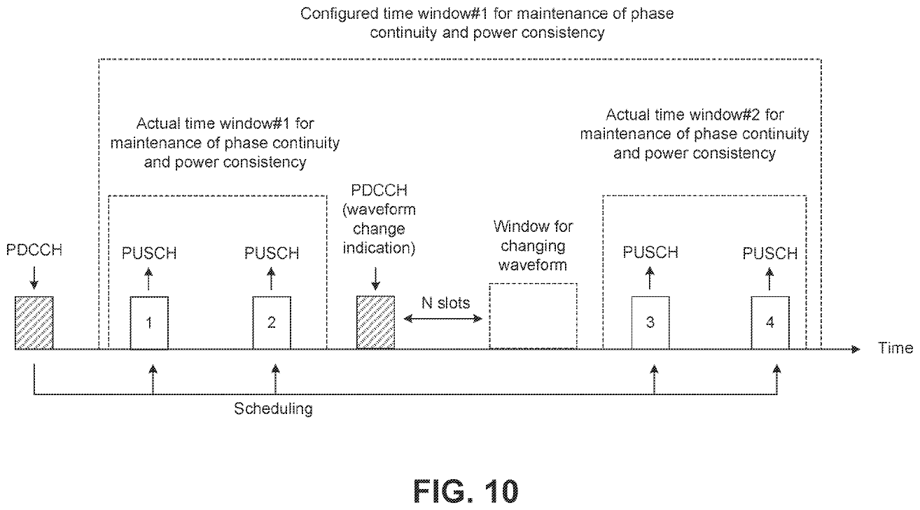

FIG. 10 illustrates an example of waveform switch and joint channel estimation. The WTRU may be configured to maintain phase continuity and power consistency across PUSCH repetitions (e.g., such that joint channel estimation can be performed by the network). The WTRU may (e.g., may need) to (e.g., in such a case) determine the interval during which the WTRU may (e.g., may need to) perform continuity and consistency maintenance. As illustrated in FIG. 10, the WTRU may be configured by the network to maintain phase continuity and power consistency across PUSCH repetitions. If the WTRU receives an indication to switch waveform during a configured time window, the WTRU may determine to create a window (e.g., an actual window) to maintain phase continuity and power consistency if (e.g., after) the WTRU completes switching the waveform.

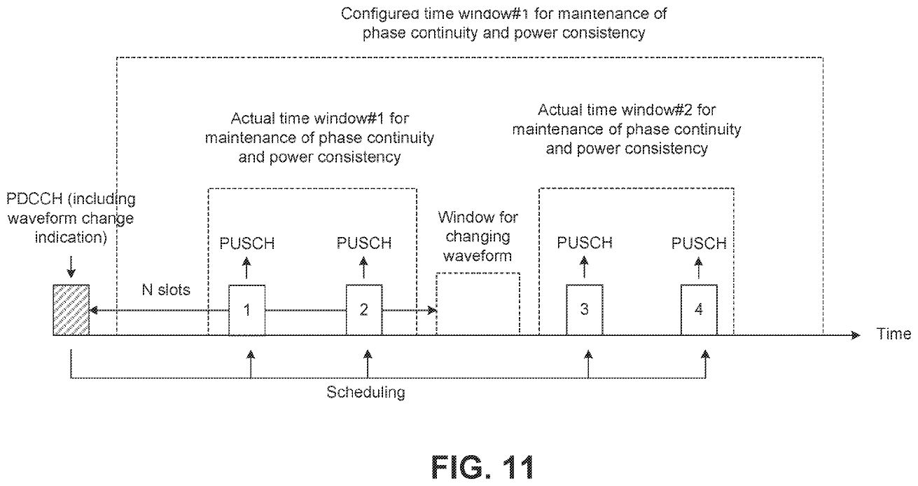

FIG. 11 illustrates an example of waveform switch and joint channel estimation. As shown in FIG. 11, the WTRU may receive a transmission schedule for PUSCH repetitions and a waveform switch indication in the same PDCCH. From the same PDCCH, the WTRU may determine the timing and duration to switch waveform types (e.g., which is indicated by “Window for changing waveform” in FIG. 11). The WTRU may determine to create windows (e.g., two actual windows), before or after switching the waveform type, while maintaining phase continuity and power consistency during the actual windows (e.g., each actual window). Phase continuity and power consistency may be not guaranteed across actual windows (e.g., phase continuity and power consistency between PUSCH #2 and PUSCH #3 may not be achieved).

Examples of timing with respect to configuration related to phase/power continuity/consistency maintenance are provided herein. In examples, the WTRU may receive a joint channel estimation related configuration to perform phase/power continuity/consistency maintenance via an RRC (e.g., duration, start/end time to maintain power consistency and/or phase continuity).

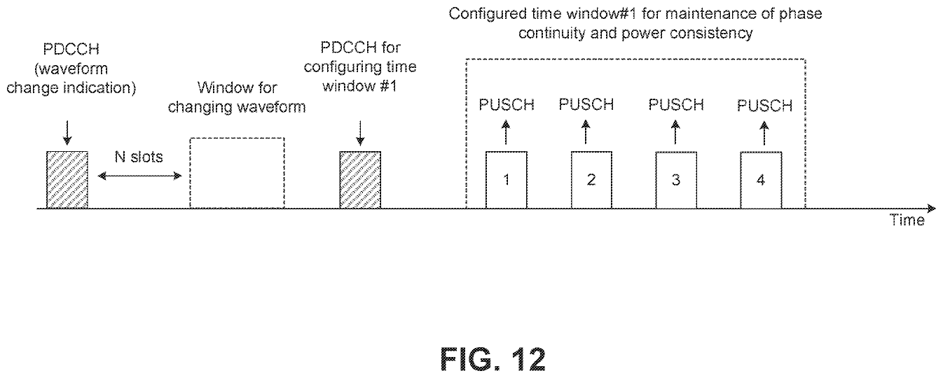

FIG. 12 illustrates an example of receiving a waveform change indication prior to a time window configuration for a joint channel estimation. If the WTRU receives an indication to switch a waveform type from the network prior to receiving the configuration related to joint channel estimation, the WTRU may determine to maintain phase continuity and power consistency for PUSCH(s) or PUCCH(s) with the switched waveform type (e.g., for which the WTRU may be expected to maintain phase continuity and power consistency). As shown in FIG. 12, the PDCCH for configuring the time window may be received by the WTRU after the waveform change indication is received by the WTRU. The WTRU may maintain phase continuity and power consistency for PUSCH(s) or PUSCH repetitions (e.g., as shown in FIG. 12) during the configured time window.

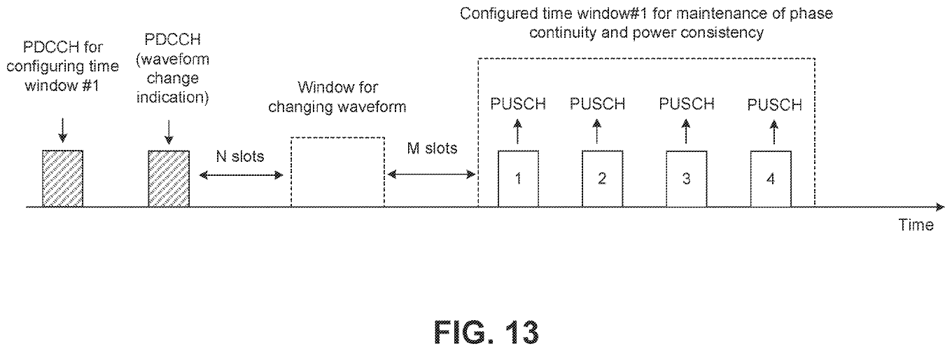

FIG. 13 illustrates an example of receiving waveform change indication after the time window configuration for joint channel estimation. If the WTRU receives the indication to switch the waveform after the WTRU receives RRC configuration related to joint channel estimation, the WTRU may determine to cancel maintenance of phase continuity and power consistency for the switched waveform for scheduled PUSCH(s) or PUCCH(s). In examples, the WTRU may receive the waveform change indication within the boundary from the beginning of the configured time window during which the WTRU may be expected to maintain phase continuity and power consistency across PUSCH/PUCCH repetitions. As shown in FIG. 13, the PDCCH for waveform indication and corresponding window for changing waveform may finish M slots away from the beginning of the configured window #1. If the boundary is B slots where M<B, the WTRU may determine to cancel maintenance of phase continuity and power consistency during the configured window. If the boundary is B slots where M<B, the WTRU may determine to cancel PUSCH transmissions. If the WTRU receives the indication to switch the waveform type after the WTRU receives an RRC configuration related to joint channel estimation, the WTRU may determine to cancel maintenance of phase continuity and power consistency during the configured window.

Examples of application delay of waveform switching in cases of repetitions and/or joint channel estimation are provided herein. In examples, the WTRU may delay application of a waveform switching command until the end of a protected window defined by a set of PUSCH repetitions and/or an actual or nominal time window for maintaining phase and/or power consistency. A protected time window may be defined by at least one of the following: between the start of first repetition of a PUSCH (or at the last symbol of a PDCCH indicating a set of PUSCH repetitions) and the end of last repetition of a PUSCH; or an actual or nominal time window over which the WTRU maintains phase and/or power continuity. The WTRU may receive signaling to change a waveform type at a first time and apply a change of waveform type to transmissions occurring from a second time. The second time may be the earliest time satisfying at least one of the following conditions: an earliest application in case such does not occur during a protected time window; or the end of a protected time window (e.g., in case the earliest application time falls within the protected time window).

The earliest application time may correspond to a delay after reception of last symbol of PDCCH indicating change of waveform, or after transmission of first or last symbol of PUCCH or PUSCH including a corresponding HARQ-ACK. The delay may be pre-defined or configured by higher layers.

Examples of fallback behavior are provided herein. Switch back/fallback behavior conditions may be provided. In examples, the WTRU may determine to fallback to the previously configured waveform type if at least one of the conditions is satisfied: the WTRU is configured with a timer which starts when the WTRU switches the waveform type; the WTRU is configured with a time window; PUSCH or PUCCH transmission(s) are associated with the indicated waveform type; or the switched waveform type is associated with a grant and the WTRU determines to switch back to the previously configured/default waveform type when the grant is terminated or expires.

For the WTRU being configured with a timer which starts when the WTRU switches the waveform type, the timer may start at the beginning of the PUSCH the WTRU transmits with the switched waveform. The timer may start when the WTRU uses the PDSCH/PDCCH, which may include the indication to switch the waveform type. If the timer expires (e.g., after the timer expires), the WTRU may switch back to the previously configured/default waveform type. In examples, if the previously configured waveform type is OFDM, and the timer associated with the switched waveform type (e.g., DFT-s-OFDM) expires, the WTRU may switch back to OFDM.

For the WTRU being configured with a time window, inside the time window, the WTRU may use the indicated waveform. After the time window, the WTRU may switch back to the first waveform type.

For PUSCH or PUCCH transmission(s) associated with the indicated waveform, the WTRU may be configured with OFDM. The WTRU may receive a PDCCH from the network, indicating to use DFT-s-OFDM for scheduled PUSCH repetitions. After completion of the scheduled PUSCH repetitions, the WTRU may switch back to OFDM.

For the switched waveform associated with a grant and the WTRU determining to switch back to the previously configured/default waveform type when the grant is terminated or expires, the WTRU may receive an order from the network to switch the waveform type and keep using the waveform for the grant the WTRU is given/scheduled/granted. In examples, the WTRU may be configured with OFDM for UL transmission. The WTRU may receive a PDCCH from the network, which may grant the WTRU a dynamic grant. The WTRU may receive (e.g., additionally receive) an indication to switch to DFT-s-OFDM for the dynamic grant. If the dynamic grant is terminated, or the dynamic grant expires or ends, the WTRU may determine to switch back to the previously configured/default waveform type (e.g., OFDM).

Examples of whether to switch back to the default waveform type may be provided. In examples, if the WTRU receives an indication from the network to change the waveform type, the WTRU may determine to continue using the switched waveform type until the WTRU receives another command (e.g., via DCI or MAC-CE) or configuration (e.g., via an RRC) from the network to change to another waveform or the first waveform. In examples, the WTRU may be configured with an OFDM initially. If the WTRU receives an indication from the network (e.g., via PDCCH) to switch the waveform to DFT-s-OFDM, the WTRU may determine to continue using DFT-s-OFDM for UL transmission until the WTRU receives a configuration or indication to switch back to OFDM.

Examples of waveform dependency on TCI state instance or pool are provided herein. In examples, a WTRU may determine the waveform applicable to a PUSCH or a PUSCH repetition based on the Transmission Configuration Indication (TCI) state, the TCI state instance, or the TCI state pool applicable to the transmission. The WTRU may be indicated in a first (or a second) TCI state instance with a first (or a second) waveform indication in a first (or a second) DCI or MAC CE, respectively. The WTRU may (e.g., may then) perform transmission of a set of PUSCH repetitions, where the PUSCH repetitions (e.g., each PUSCH repetition) may be associated to a first (or a second) TCI state instance. Such transmission of a set of PUSCH repetitions may be indicated by a third DCI or configured by higher layers as a configured grant. The indication or configuration may indicate a mapping between PUSCH repetitions (e.g., each PUSCH repetition) and an associated TCI state instance. The WTRU may (e.g., may then) transmit a PUSCH using first (second) waveform for PUSCH repetitions associated with first (or a second) TCI state instances.

Examples of prioritization for waveform switch may be provided. Examples may apply to both dynamic waveforms switching and semi-static waveform switching. Examples of waveform switching configurations per cell may be provided.

The WTRU may determine that a cell supports waveform switching prior to accessing/camping on the cell. The WTRU may determine that a cell supports waveform switching using the broadcasted SIBs messages from the cell. The SIB messages may include a set of supported waveforms and the switching mode between different waveforms (e.g., dynamic, or semi-static waveform switching). The WTRU may determine that a cell supports waveform switching based on a configuration received from the serving cell. In examples, the RRC CONNECTED WTRU may receive from its serving cell, the set of waveforms supported by neighboring cell(s). In examples, the WTRU may be configured to associate a cell ID with a set of waveforms. The WTRU may be pre-configured with a mapping between cell IDs and sets of waveforms and/or the waveform switching capability.

The WTRU may determine that a cell is supporting waveform switching/multiple waveforms based on RACH resource configuration. In examples, the WTRU may determine that a cell supports multiple waveforms (e.g., two waveforms) and/or waveform switching if the RACH configuration of a cell includes PRACH formats for a different waveform. A PRACH format may be associated with specific waveform. A first PRACH format may be associated with a first waveform type and a second PRACH format may be associated with a second waveform type. The WTRU may determine that a cell supports waveform switching based on PRACH resource partitioning and an associated waveform with a sub-set of PRACH resources. Subsets of RACH occasions may be associated with different waveform types (e.g., OFDM and DFT-s-OFDM). BWP or bands may be associated with different waveform types (e.g., Band#1 for OFDM and Band#2 for DFT-s-OFDM).

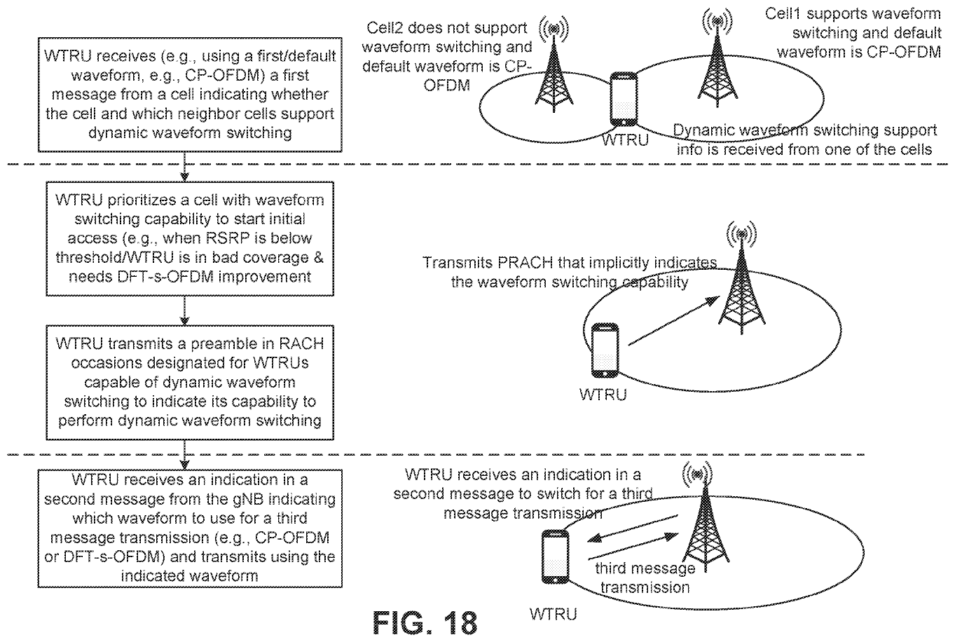

Features associated with cell selection/prioritization based on waveform configuration are provided herein. The WTRU may be configured to prioritize among cells during initial access procedures and/or during measurement reporting of neighboring cells. Based on the set of supported waveforms and/or the availability of waveform switching functionality within a cell, the WTRU may prioritize one cell over another. In examples, during initial access, the WTRU may be configured to prioritize a cell with waveform switching functionality if the WTRU is in a coverage limited scenario with respect to that cell. In examples, the WTRU may not select a cell if the measured RSRP of reference signals is below a configured threshold and the cell is not supporting or indicating waveform switching. In examples, the WTRU may select a cell if the measured RSRP of its reference signals is below a configured threshold and the cell supports waveform switching (e.g., as illustrated in FIG. 18). The reference signals of the cell may include synchronization signals (SS) and/or DMRS of the PBCH and/or DMRS of CORESET 0. The WTRU may select/prioritize a cell based on a combination of one or more of the following: measured RSRP; capability of the WTRU; waveform/waveform switching capability (or indication) of the cell; cell ID; bandwidth of the cell; or the licensed or unlicensed cell.

For the measured RSRP, the WTRU may determine the RSRP of the cell (e.g., from SSB measurements during the initial access procedures or during the RRM measurements). For the capability of the WTRU, the WTRU may select a cell based on what waveforms the WTRU is capable of using/supporting. For waveform/waveform switching capability (or indication) of the cell, the WTRU may select a cell based on the measured RSRP of the cell and the supported waveforms/switching (e.g., as illustrated in FIG. 18). For the cell ID, if the WTRU determines that a group of cells have the same waveform/waveform switching capabilities or indications, the WTRU may prioritize a cell based on its cell ID. In examples, the WTRU may select a cell with smaller cell ID value. For the bandwidth of the cell, the WTRU may prioritize a cell with larger bandwidth over a cell with smaller bandwidth. For the licensed or unlicensed cell, the WTRU may prioritize a cell with an unlicensed spectrum over a cell with a licensed spectrum.

In examples, prior to establishing initial access, the WTRU may communicate with a cell (e.g., a second cell) using a first waveform type. The WTRU may receive a first message (e.g., via an RRC transmission or a SIB transmission) from cell(s) (e.g., from a first cell) (e.g., as shown in FIG. 18). The first message may indicate whether cell(s) (e.g., neighboring cell(s) support dynamic waveform switching (e.g., may indicate whether a second cell of the neighbor cell(s) supports dynamic waveform switching, for example, as shown in FIG. 18). If the first message (e.g., SIB transmission) includes an indication that a cell (e.g., the second cell) supports dynamic waveform switching, the WTRU may determine to prioritize establishing initial access (e.g., as shown in FIG. 18) with the second cell over cells (e.g., a third cell) that do not support dynamic waveform switching, where in some examples the determination to prioritize and establish initial access may be further based on a respective measurement of each cell of the neighboring cell(s) being below a threshold as described herein (e.g., as shown in FIG. 18). Such prioritization may be realized by applying an offset to the RSRP or RSRQ measurement result of a cell if the WTRU supports a certain waveform type or switching between waveform types. The cell may be a serving cell or a neighbor cell. The offset applicable to cells (e.g., each cell) and the corresponding waveform or waveform switching indication may be received by system information. The offset may be fixed or configured as common offset to neighbor cells (e.g., all neighbor cells) for which a waveform or waveform switching is indicated.

During RRC_CONNECTED, the WTRU may receive configuration from the network which indicates resources used for UL transmission for dynamically switching waveforms. Examples of such resources may include carrier component, bandwidth part (BWP), and/or band. The WTRU may be configured to start random access procedure on multiple cells and select a cell based on waveform switching configuration received in the random-access response(s). In examples, the WTRU may initiate random access (RA) procedures on two cells (cell 1 and cell 2). The WTRU may receive a first random access response (RAR) from cell 1 indicating single waveform support or not supporting waveform switching. The WTRU may (e.g., may also) receive a second RAR from cell 2 indicating the support of waveform switching. The WTRU may select cell 2 to continue its RA procedures and stop initial access procedure on cell 1.

Examples of data selection and multiplexing based on waveform(s) associated with the UL grant may be provided. The WTRU may be configured by higher layers (e.g., RRC signaling) or predefined with an association between LCH and one or more applicable waveform(s). The LCH may be a data radio bearer (DRB) or SRB LCH. For a given UL grant for a transmission (e.g., an initial transmission) of data, the WTRU may determine the applicable waveform type. The WTRU MAC may multiplex UL data from LCHs (e.g., only from LCHs) configured with the waveform of the UL grant (e.g., part of the logical channel prioritization procedure (LCP)). The WTRU may be configured or predefined with an association between a waveform type and a priority index. The WTRU may determine the waveform type associated with the grant from the signaled priority index associated with the grant. The WTRU MAC may multiplex UL data from LCHs (e.g., only from LCHs) configured with a priority index associated with the waveform of the UL grant.

The WTRU may be configured by higher layers (e.g., RRC signaling) or predefined with an association between certain MAC CEs or MAC CE formats and one or more applicable waveform(s). The WTRU may multiplex a PHR MAC CE format associated with a certain waveform scheme (e.g., DFT-s-OFDM) and/or reflecting real PHR if (e.g., only if) the grant on which the MAC CE is multiplexed is of that waveform type.

Examples of waveform determinations based on HARQ process ID or grant type are provided herein. The WTRU may be configured (e.g., by RRC signaling) with an association between a waveform type and a subset of HARQ process IDs. In examples, an RRC may configure the WTRU such that waveform A (e.g., DFT-s-OFDM) may be associated with hybrid automatic repeat request (HARQ) processes 0 to 12, and waveform B (e.g., OFDM) may be associated with HARQ processes 13 to 15. If receiving an UL grant for a transmission, the WTRU may determine the waveform to use for a UL transmission on the grant from the associated HARQ process ID.

The WTRU may be configured or predefined with an association between a grant type and waveform type. The WTRU may determine the waveform type to use for transmission on the UL grant from whether the grant is configured grant type 1, configured grant type 2, a dynamic grant, a grant for msg3, a grant for msgA, or a grant for msg5. Such association may be specified instead of configured.

The WTRU may receive an indication which associates a waveform with a grant. In examples, the WTRU may receive an indication to switch the waveform type for a dynamic grant scheduled for the WTRU. The indication may be included in PDCCH or PDSCH. Based on the indication, the WTRU may determine to switch the waveform type if the grant is scheduled/activated or configured.

By adaptively switching the waveform type for UL transmission, the coverage performance or throughput performance may be improved. Examples of switching waveform types for initial access are provided herein. Examples of indications of WTRU capability during initial access are provided herein.

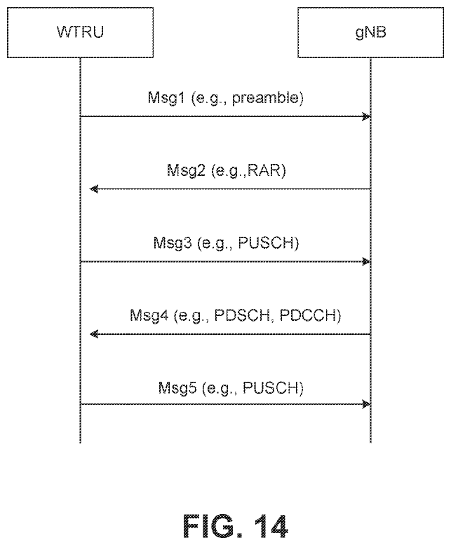

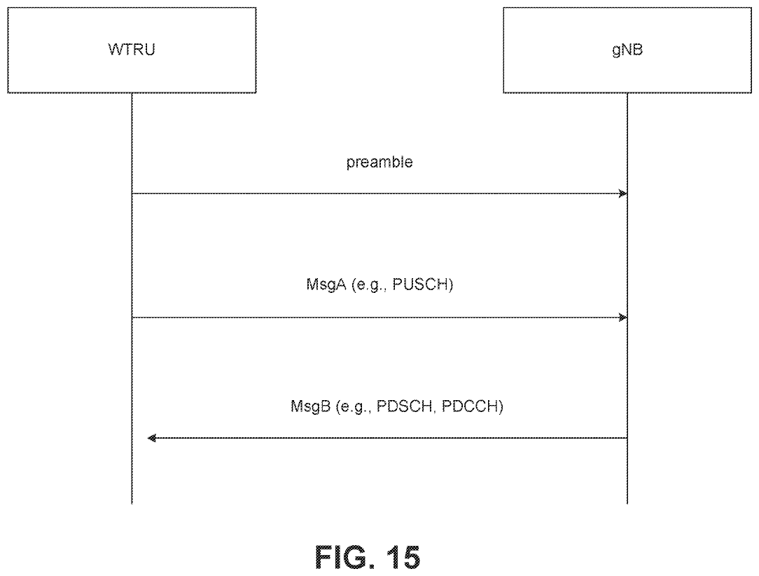

FIG. 14 illustrates an example of a 4-step initial access RACH procedure. FIG. 15 illustrates an example of a 2-step initial access RACH procedure. Switching waveforms dynamically may require hardware at the WTRU which may allow a quick switch between waveform types (e.g., between DFT-s-OFDM and OFDM). During RRC_CONNECTED, the WTRU may send the WTRU capability information (e.g., the WTRU may be capable of switching waveform directly) to the network. Since the network may not have the WTRU capability information before the initial access is established successfully, there may be a need for the WTRU to indicate its capability to switch waveforms dynamically during the initial access.

The WTRU may initiate the initial access, which may allow dynamic waveform switching in at least one of the following configurations: the WTRU transmits a preamble in transmission occasion(s) used for the preamble transmissions (e.g., RACH occasion(s), which may be defined by time and/or frequency resources) that may be designated for indicating the WTRU can support dynamic waveform switching (e.g., as shown in FIG. 18); the WTRU transmits a preamble via a resource used for the preamble transmission; the WTRU transmits a preamble in cases the WTRU does not indicate the capability information explicitly; or the WTRU transmits a preamble via a preamble sequence that is associated with the waveform the WTRU is requesting to use for msg3/msg5/general PUSCH transmission.

For the WTRU not indicating the capability information explicitly, such a situation may arise if there is not enough time and/or frequency resources for the network to allocate RACH occasions for the WTRU(s) to indicate their capability to switch waveforms dynamically. The WTRU may transmit a preamble (e.g., in this case) in RACH occasions that may be used for existing purposes (e.g., indicating a request for msg3 repetitions, coverage expansion, WTRU capability for small data transmission). For the WTRU transmitting a preamble sequence which is associated with the waveform type the WTRU is requesting to use for msg3/msg5/general PUSCH transmission, the parameter of the sequence may be broadcasted or sent in dedicated signaling by the network. The WTRU may determine to transmit the preamble sequence to request the waveform type if the WTRU is preconfigured with a waveform type by the network prior to establishing the initial access. If the network receives the preamble (e.g., in the examples herein), it may determine that the WTRU is capable of switching waveforms dynamically. The network may not know whether the WTRU can switch waveform dynamically (e.g., in examples herein where the WTRU has not indicated its capability of dynamically switching waveforms). In examples, the WTRU may include its capability information (e.g., capable of switching waveforms directly) in msg3 or msgA.

Examples of how the default waveform type is configured may be provided. The WTRU may determine the default waveform type based on broadcast information from the network (e.g., SIB) or dedicated signaling. If the WTRU does not receive broadcast information or dedicated signaling by the network, the WTRU may determine to use predefined waveform type (e.g., OFDM).

Examples of switching priority/when the WTRU is indicated to switch may be provided. If the WTRU is preconfigured with more than one waveform type (e.g., OFDM with different MCSs, DFT-s-OFDM with different MCSs), the WTRU may receive broadcast information or dedicated signaling from the network on the list of priority to switch waveform types. In examples, the WTRU may be preconfigured with OFDM with QPSK, DFT-s-OFDM with QPSK, and DFT-s-OFDM with pi/2 BPSK. The WTRU may receive a priority list from the network, indicating the order of preference, OFDM with QPSK, DFT-s-OFDM with QPSK, DFT-s-OFDM with pi/2 BSPK, where OFDM with QPSK may be the first waveform type (e.g., default waveform type) and MCS. If the WTRU determines to switch the waveform type from the first waveform type and MCS, the WTRU may determine to switch to a second waveform type (e.g., DFT-s-OFDM) with QPSK according to the priority list received from the network. The priority list may be broadcasted or sent in dedicated signaling by the network. The WTRU may be configured with the list while the WTRU was in RRC_CONNECTED and save the configuration if the WTRU falls to IDLE or INACTIVE state.

The WTRU may be configured with a list of waveform types (e.g., two waveform types) only. When the WTRU determines to switch the waveform type, the WTRU may switch to the waveform type the WTRU is not using for UL transmission.

The WTRU may receive an indication to switch waveform types in msg2 or msg4 (e.g., as shown in FIG. 18, where msg2 or msg4 may be the second message). If the WTRU indicates a request to switch the waveform type in msg1, the WTRU may receive the indication from the network to switch the waveform type in msg2 If the WTRU includes its capability to switch waveforms dynamically, the WTRU may receive the indication from the network to switch waveform type in msg4.

Examples of WTRU behavior for msg3 may be provided. If the network does not allocate RACH occasions for indication of dynamic waveform switch, the WTRU may determine to perform at least one of the following: depending on the conditions (e.g., RSRP of SSB below the preconfigured threshold), the WTRU may determine to switch the waveform type from the default waveform type for msg3 transmission; if msg2 (e.g., RAR) includes a grant offset (e.g., number of slots, frames, symbols) and if the WTRU determines to switch the waveform type from the default waveform type, the WTRU may send msg3 at a grant which is offset from the grant configured in msg2; if msg2 (e.g., RAR) includes fallback RAR, and if the WTRU determines to switch the waveform type from the default waveform type, the WTRU may send msg3 at a grant which is offset by preconfigured offset value from the grant configured in msg2 (e.g., the WTRU may obtain the offset value from broadcast or in dedicated signaling sent from the network); or if preconfigured by the network, the WTRU may monitor more than one search space for RAR indicating to switch the waveform type for msg3 repetition. Based on the quality (e.g., RSRP) of preamble, the network may determine to send RAR in the search space which is allocated for configuring msg3 transmission parameters (e.g., waveform, grant)

The WTRU may determine a default waveform type (e.g., OFDM) to use during initial access based on indication received on broadcast information from the network (e.g., SIB), dedicated signaling (RRC (re)-configuration), or being predefined.

The WTRU may determine a non-default waveform type (e.g., DFT-s-OFDM) to use during initial access based on an indication received on broadcast information from the network (e.g., SIB) or dedicated signaling (RRC (re)-configuration). If the WTRU does not receive broadcast information (e.g., during the initial access), the WTRU may determine to use a predefined waveform type (e.g., OFDM). The WTRU may have a capability of using a non-default waveform type or switching between different waveform types. A WTRU capable of such multiple waveforms may acquire broadcast configuration (e.g., additional broadcast configuration) or system information (e.g., additional system information), possibly on a separate SIB, possibly before initiation of a RA (e.g., during initial access). The WTRU may be configured by broadcast information of which waveform to use for msgA or msg3, possibly per PRACH resource (e.g., a subset of preambles and/or RACH occasions).

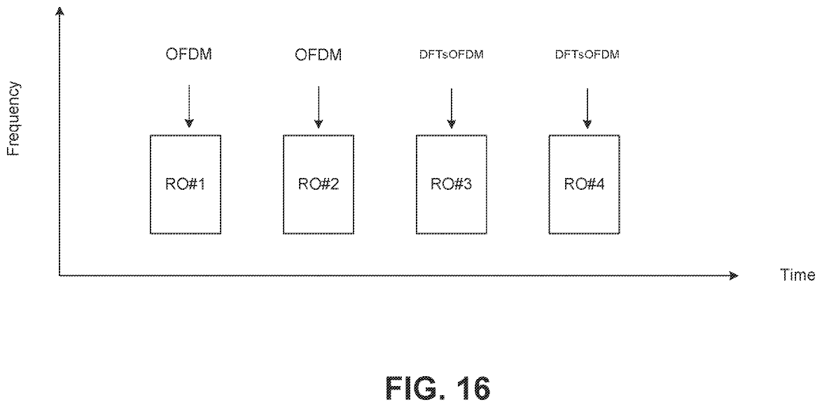

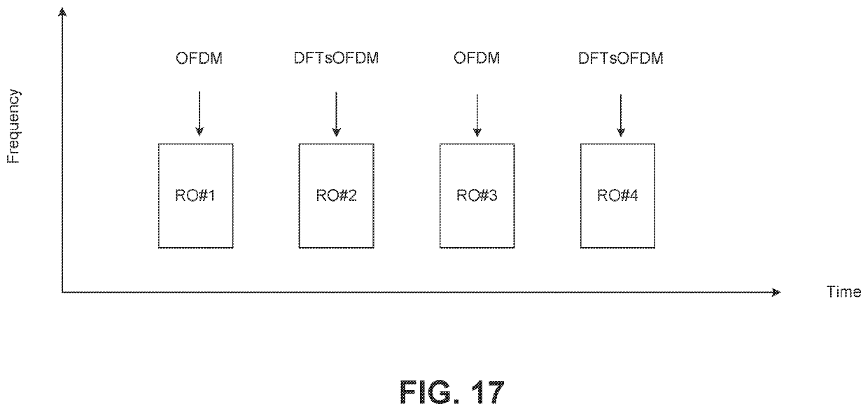

FIGS. 16-17 illustrate examples of association between ROs and waveforms. As shown in FIG. 16, the WTRU may request for OFDM by sending a preamble in RO#1. A subset of ROs may correspond to a different SSB and the WTRU may indicate the waveform type the WTRU requests by transmitting a preamble at the associated RO. The subset of ROs corresponds (e.g., also) corresponds to the SSB from which the WTRU may measure RSRP above the preconfigured threshold. The ROs (e.g., each RO) may indicate to the network the waveform type the WTRU desires and spatial direction and/or width of SSB from which the WTRU observes sufficiently large RSRP.

Examples of indication of waveform capability in msg1 may be provided. The WTRU may indicate (e.g., may implicitly indicate) the capability associated with support of dynamic waveform switching (e.g., between DFT-s-OFDM and OFDM) by msg1 PRACH resource selection. The WTRU may indicate this capability by msg1 selection in a subset (e.g., only in a subset) of RRC states (e.g., RRC IDLE and/or RRC Inactive modes). The WTRU may determine to transmit the PRACH sequence to request a certain waveform (e.g., on an RO associated with indication of such capability) if the WTRU is preconfigured with the waveform type by the network (e.g., prior to establishing the initial access/RA).

The WTRU may be configured (e.g., by broadcast or dedicated signaling) with a partition of PRACH resources (e.g., a subset of preambles and/or ROs) to be selected by the WTRU during a RA procedure (e.g., as a part of initial access). The partition of PRACH resources may be configured to indicate the capability of supporting of more than one waveform type, a non-default waveform, and/or waveform switching. In examples, the WTRU may use msg1 PRACH resource partition (e.g., already configured for the purpose of indication coverage limitation) to indicate (e.g., also indicate) the capability of waveform switching, including at least: the partition configured for indication of a capability of msg3 repetition; and/or indication of coverage level (e.g., a measurement (e.g., RSRP) being less than the threshold configured for msg3 repetition). The WTRU may be configured or predefined to select the msg1 or msgA PRACH resource partition (e.g., already configured) for the purpose of indicating small data transmission (SDT) if the WTRU is capable of multiple waveform types and/or waveform switching. The WTRU may select a specific partition (e.g., one associated with indication of waveform capability switching, coverage limitation, or SDT) if the measured RSRP is below a threshold. Otherwise (e.g., if the measured RSRP is not below a threshold), the WTRU may select legacy RACH resources.

The WTRU may be configured with parameters (e.g., alternate parameters) to use for the purpose of msg1 transmission or retransmission if it is capable of waveform switching and/or if it selects an RO partition associated with indicating a waveform (e.g., alternate waveform) or indication the capability of multiple waveforms. Such parameters may be configured by broadcast or dedicated signaling. Specific parameters (e.g., alternate parameters) may include: a differentiated transmit power; a differentiated tx spatial filter; a number of msg1 repetitions; a differentiated backoff; a differentiated power ramping step; a different Zadoff Chu root sequence (or logical root sequence index); or a different sequence shift set (e.g., a different Ncs). The WTRU may apply such differentiated parameters if it initiates an RA on a RO associated with indication of a waveform switching capability and/or if the preamble is transmitted using a different waveform type.

The WTRU may be configured to switch to an RA partition configured for indication of coverage limitation or capability of waveform switching if a configured number of msg1 and msg3 are retransmitted (e.g., after a configured number of msg1 retransmissions and/or msg3 retransmissions) (e.g., using a first waveform/default waveform type).

Examples of indication of waveform capability in PUSCH payload (e.g., in msgA or msg3) may be provided. The WTRU may include its capability information (e.g., capable of switching waveforms, support of multiple or a different/non-default waveform) part of the payload msg3, msgA, or part of small data PDU multiplexed on a RA-SDT or a CG-SDT resource. The WTRU may be configured with a partition of CG-SDT resources, over which the WTRU may use a different waveform type (e.g., non-default waveform type) for the PUSCH SDT transmission. The WTRU may multiplex a predefined or differentiated DMRS on the msg3 or msgA PUSCH transmission if it is capable of a different waveform type (e.g., non-default waveform type), if msg3 is transmitted using a different waveform type (e.g., non-default waveform type), and/or to indicate the capability of supporting a different waveform type (e.g., non-default waveform type). The DMRS may be generated as a function of the signaled temporary C-RNTI or the RA-RNTI.

Examples of signaling of waveform type(s) in msg2 or msgB are provided herein. Examples of indication of waveform capability by grant selection/transmission are provided herein. If the WTRU supports capability of multiple waveform types, and such capability is not indicated part of msg1/msgA, the network may not know whether the WTRU can switch waveform dynamically by mere reception of msg1/msgA. The WTRU may receive a grant supporting more than one waveform type, multiple grant types for different waveform types in the same RAR, and/or multiple RAR to support msg3 grants of different waveform types.

The WTRU may receive the legacy RAR format but may interpret the UL grant parameters differently if the WTRU is capable of waveform switching. The WTRU may receive a UL grant in RAR, but the resource allocation (in time and/or frequency) may be interpreted differently depending on the waveform capability of the WTRU. The WTRU may apply a predefined or configured shift or offset in the time and/or in the frequency domain to the signaled UL grant allocation in RAR (e.g., if the WTRU uses a different waveform type (e.g., DFT-s-OFDM). If a grant offset (e.g., number of slots, frames, symbols) is applied and if the WTRU determines to switch the waveform from the first waveform type (e.g., default waveform type), the WTRU may transmit msg3 using a grant that is offset from the allocation indicated in msg2. The WTRU may obtain the offset value from a broadcast from the network. Such WTRU behavior may be applicable by the WTRU for (e.g., only for) fallback RARs (e.g. msg2 received following the transmission of msgA) or after a number of msg1 or msg3 retransmission attempts. The WTRU may select a RACH partition associated with coverage enhancement or indication of a different waveform type (e.g., non-default waveform type) if it reverts to 4-step RA following N configured failed attempts on 2-step RA.

In examples, the WTRU capable of multiple waveform types may monitor RAR on one or more search spaces, one or more coresets, and/or one or more RA-RNTI. The WTRU may monitor for a RAR (e.g., an additional RAR) on a search space (e.g., separate search space from that configured for legacy WTRUs) for the reception of a RAR that may include an UL grant. The UL grant may be transmitted using a different (e.g., non-default waveform (e.g. DFT-s-OFDM). Such a search space may be a common search space (e.g., for WTRUs capable of waveform switching) or a WTRU specific search space.

The WTRU may monitor for a RAR (e.g., an additional RAR) on a separate RA-RNTI from that used for legacy WTRUs for the selected RO. In examples, the WTRU may apply an offset to the determined RA-RNTI or msgB-RNTI if it is capable of multiple waveforms. The WTRU may monitor such search space (e.g., additional search space) and/or RA-RNTI if (e.g., only if) configured by the network or if measured channel conditions fall below a configured threshold. In the event the WTRU receives multiple msg3 grant and/or RARs, the WTRU may select the grant or select to decode a RAR associated with a different waveform type (e.g., non-default waveform type) if the measured channel conditions (e.g., RSRP) fall below a configured threshold. The WTRU may transmit using signaled (e.g., all signaled) msg3 grants associated with the WTRU's RA-RNTI(s), possibly repeating msg3 content if the grant size is the same for grants (e.g., all grants) and/or if the coverage level is below a threshold. The WTRU may be configured with a subspace of TC-RNTIs or C-RNTI, such that if the temporary C-RNTI indicated in RAR falls within such subspace, the WTRU may use a different waveform type (e.g., non-default waveform type) for the transmission of msg3 and UL transmissions (e.g., subsequent UL transmissions).

The WTRU may receive an indication to switch waveform types in msg2 (e.g., to a different/non-default waveform type) (e.g., as shown in FIG. 18). In examples, the WTRU may receive the indication from the network to switch the waveform type in msg2, possibly if the WTRU indicates a request to switch the waveform in msg1 (e.g., by selection of an RA partition associated with such capability). The indication may be carried as bit flag part of the RAR PDSCH payload, a bit part of L2 MAC RAR subPDU, a bit in the MAC subheader, a reserved bit in MAC RAR subPDU, or an indication in the PDCCH signaling that scheduled the RAR (e.g., determined from DCI format, TDRA, FDRA, overloading the MCS field, or explicit indication in the DCI). The WTRU may apply the indicated waveform type in msg2 for the transmission of msg5 or UL grants/transmission following the successful completion of the RA (e.g., as shown in FIG. 18). The WTRU may keep using the same waveform type used in msg3 in msg5 if contention resolution was successful.

The WTRU may receive a DCI indicating a msg3 retransmission (e.g., DCI0_0) that indicates (e.g., also indicates) to the WTRU which waveform type to use for the retransmission of msg3 (e.g., determined from DCI format, TDRA, FDRA, overloading the MCS field, or explicit indication in the DCI). The WTRU may receive an indication of which waveform type to use for UL transmissions (e.g., subsequent UL transmissions) part of a PDCCH order of a contention free RA.

Examples of waveform selection for transmission of msg3 may be provided. The WTRU may perform dynamic determination of which waveform type to use for msg3/msg5 transmission, possibly the capability (e.g., only the capability) of multiple waveform support was indicated to the network part of msg1, msgA, or prior PUSCH transmissions.

The WTRU may determine to switch a waveform from the first waveform type (e.g., default waveform type, which may be an OFDM waveform type) for a msg3 transmission if at least one or more of the following conditions are met: based on channel condition(s), if the RSRP of SSB is below the preconfigured threshold; based on parameters signaled for the UL grant, the WTRU may determine which waveform type to use for the transmission of msg3 from the value signaled for the UL grant allocation, the value signaled for the MCS, or depending on other parameters associated with the UL grant; assuming that OFDM is the first waveform type (e.g., default waveform), if the number of resources (e.g., resource elements, RBs) is smaller than the preconfigured threshold, the WTRU may determine to switch to a DFT-s-OFDM waveform type for msg3 transmission; if MCS configured for the grant is pi/2 BPSK or any MCS that is applicable (e.g., only applicable) to a DFT-s-OFDM waveform type, the WTRU may determine to switch to a DFT-s-OFDM waveform type for msg3 transmission; if corresponding power change for the accumulated TPC or TPC command is below the preconfigured threshold, the WTRU may determine to switch to a DFT-s-OFDM waveform type; based on the number of msg3 repetitions signaled for msg3, the WTRU may transmit msg3 with a different (e.g., non-default) waveform type if the number of msg3 repetitions signaled is higher than 1 or higher than a configured or predefined number; based on the signaled TA value, the WTRU may determine which waveform type to use for the transmission of msg3 from the value signaled for timing advance or if certain preconfigured values are signaled; if the TA value is higher than a threshold, the WTRU may determine to use a DFT-s-OFDM waveform type since based on the TA value, the WTRU may determine that it is located relatively far from the base station; or based on the retransmission number associated with msg3, if the first waveform type (e.g., default waveform type) is OFDM and the number of retransmission number is greater than a preconfigured threshold, the WTRU may determine to switch to a DFT-s-OFDM waveform type for msg3 transmission.

Examples of signaling of waveform type in msg4 may be provided. The WTRU may receive an indication to switch waveforms in a second message (e.g., msg4 or msgB) from a cell (e.g., as shown in FIG. 18). If the WTRU indicates a request to switch the waveform in msg3 or msgA, the WTRU may receive the indication from the network to switch the waveform type (e.g., switch from a CP-OFDM waveform type to a DFT-s-OFDM waveform type) for UL transmissions (e.g., subsequent UL transmissions) in the second message (e.g., msg4 or msgB). The WTRU may receive indication of a waveform part of the payload of the contention resolution MAC subPDU or the msgB payload. The WTRU may apply the indicated waveform type (e.g., the DFT-s-OFDM waveform type) for the transmission of a third message (e.g., msg5 or UL grants/transmission) (e.g., following the successful completion of the RA) (e.g., as shown in FIG. 18). The WTRU may receive an indication part of msgB on which modulation to use for PUCCH transmission(s) relating to the HARQ feedback for msgB TB or UL transmissions (e.g., subsequent UL transmissions). The WTRU may be preconfigured to return more than one PHRs in msg3 or msg5 if one of the at least one of the (e.g., aforementioned) conditions for sending PHRs is satisfied. The WTRU may be configured to send PHRs in the third message via a PUSCH transmission (e.g., msg5) such that the network can determine which waveform type to configure for subsequent PUSCH transmissions.

Examples of fallback behavior may be provided. If the WTRU is not successful in the initial access procedure in a preconfigured number of attempts, where the number of attempts may be broadcasted in SIB or dedicated signaling, the WTRU may determine at least one of the following: if the WTRU is not successful in completing the 4-step RACH procedure, if available, the WTRU may fall back to the PRACH transmission in preconfigured PRACH resources (e.g., RACH occasion for coverage expansion, indicating a request for msg3 repetition, the WTRU may select a preamble sequence from preconfigured pool of preamble sequences); or if the WTRU is not successful in completing the 2-step RACH, the WTRU may fall back to the PRACH transmission in the preconfigured RACH occasions (e.g., RACH occasion for coverage expansion, indicating a request for msg3 repetition) in the 4-step RACH procedure.

FIG. 18 illustrates an example of dynamic waveform switching. If a WTRU receives a first message (e.g., via an RRC transmission or a SIB transmission) from multiple cells (e.g., from a first cell of multiple cells) and if the WTRU determines that (e.g., if the first message indicates) a cell (e.g., a second cell of neighbor cell(s) supports dynamic waveform switching, the WTRU may determine to perform initial access by prioritizing the cell (e.g., the second cell) that supports dynamic waveform switching over cell(s) (e.g., a third cell) that do not support a dynamic waveform switching (e.g., if the WTRU is capable of dynamically switching waveforms), where in examples the prioritization may be further based on a measurement (e.g., RSRP) of the second cell being below a threshold). The WTRU may receive the first message via a first waveform type (e.g., a CP-OFDM waveform type). The WTRU may determine a RACH procedure to use. If the RSRP of an SSB is above the threshold, the WTRU may determine to initiate 2-step RACH. The WTRU may determine the first waveform type (e.g., default waveform type (e.g., OFDM waveform type or CP-OFDM waveform type)), grant offset (e.g., number of slots), and number of allowed attempts (N) from the SIB. The WTRU may transmit a preamble and a msgA. The preamble may indicate a capability of the WTRU to support dynamic waveform switching. The WTRU may receive a second message that indicates a second waveform type (e.g., a DFT-s-OFDM waveform type) to use for a transmitting a third message. If the WTRU receives a fallback RAR, the WTRU may determine transmission parameters if receiving (e.g., after receiving) the fallback RAR (e.g., where the fallback RAR includes grant information). The WTRU may determine to transmit the second waveform type (e.g., the DFT-s-OFDM waveform type) in the third message with the grant offset from the indicated grant in the fallback RAR. The WTRU may determine to fallback to 4-step RACH and use RACH partitions for coverage extension for msg1 (preamble transmission) (e.g., after N RACH failures). If the WTRU does not receive a fallback RAR, the WTRU may proceed with RRC_CONNECTION procedure (e.g., successfully established connection). If the RSRP of SSB is not above the threshold, the WTRU may initiate 4-step RACH.

Examples of transmission(s) over multiple slots and waveform switching are provided herein. Prioritization among coverage enhancement technique(s) may be provided. The WTRU may be configured with multiple coverage enhancement techniques (e.g., such as transmission of TB over multiple slots, PUSCH repetition, and waveform switching). The WTRU may be configured with multiple configured grants for UL transmission. The multiple configured grants for UL transmission may include a first uplink grant configured with a OFDM waveform type over a single slot, a second uplink grant configured with a DFT-s-OFDM waveform type over a single slot, a third uplink configured grant with a OFDM waveform type over multiple slots (e.g., TB over multiple slots (TBoMS), and a fourth UL grant with a DFT-s-OFDM waveform type over multiple slots. Such configured grants may be overlapping in time domain. The WTRU may be configured to select one grant for UL transmission. The WTRU may select/prioritize between different coverage enhancement techniques by selecting a configured grant for UL transmission corresponding to a specific coverage enhancement technique. The WTRU may determine which coverage enhancement technique(s) to use based on one or more of the following: gNB indication(s) of allowed waveform type(s) to use for UL transmission; gNB indication(s) of enabling waveform switch(es); the number of UL slots within a configured duration being below a configured threshold; the number of consecutive UL slots being above a configured threshold; whether joint channel estimation (JCE) is enabled or not; the number of allocated slots for TBoMS; the configured number of slots for PUSCH repetition; the configured max power for a waveform and the measured path loss of reference signals; the required latency for the UL transmission; or a frequency hopping configuration.

For the gNB indication(s) of the allowed waveform(s) to use for uplink transmission, the gNB may send to the WTRU an indication/configuration of the allowed waveform for UL transmissions using at least one of RRC signaling, MAC CE, or DCI. If the WTRU determines that the allowed waveform type is OFDM, the WTRU may use TBoMS instead of a single slot transmission PUSCH for a configured grant transmission. If CP-OFDM is allowed, the WTRU may use a single slot PUSCH transmission.

For the gNB indication(s) of enabling a waveform switch, the WTRU may receive a group common DCI that indicates that waveform switching is enabled. The WTRU may (e.g., in this case) autonomously determine the waveform type to use for an UL configured grant transmission.

For the number of UL slots within a configured duration being below a configured threshold, based on the received TDD configuration (dynamic or semi-static TDD configuration), the WTRU may determine that the number of UL slots within X ms are below the configured threshold Xth. The WTRU may (e.g., may then) use DFT-s-OFDM over single slot instead of TBoMS transmission with OFDM.

For the number of consecutive UL slots being above configured threshold, based on the received TDD configuration (dynamic or semi-static TDD configuration), the WTRU may determine that the number of consecutive UL slots are below the configured threshold. The WTRU may (e.g., may then) use a TBoMS transmission with a OFDM instead of a DFT-s-OFDM over a single slot.

For whether joint channel estimation (JCE) is enabled or not, the WTRU may prioritize the use of the same waveform if JCE is enabled and being used for a transmission. If the JCE is not enabled, waveform switching may be prioritized.

For the number of allocated slots for the TBoMS, the WTRU may determine that the number of allocated slots for the TBoMS is below a threshold and cannot satisfy the required reliability with the available TBS.

For the configured number of slots for a PUSCH repetition, the WTRU may use a PUSCH repetition if the number of repetitions configured for the grant is above a threshold. The WTRU may use a different waveform (e.g., waveform switching) if the number of repetitions configured for the grant is below a threshold.

For the required latency for the UL transmission, the WTRU may select transmission over a single slot with waveform switching rather than using a TBoMS transmission for a low latency requirement.

For the frequency hopping configuration, the WTRU may select the grant configured with frequency hopping over multiple slots rather than using waveform switching.

Examples of adaptation of transmission(s) over multiple slots if (e.g., after) receiving waveform switching are provided herein.

The WTRU may receive a waveform switching indication from the gNB if (e.g., while) transmitting a TB. Such transmission may be a transport block over multiple slots (TBoMS) or a transport block repetition (PUSCH repetition). In examples, the WTRU may receive a waveform switching indication/command from the gNB during the transmission of TBoMS or PUSCH repetition using a group common DCI that indicates waveform switching for an UL transmission. In examples, the WTRU may be configured to switch the waveform type during the transmission of TBoMS/PUSCH repetition. In examples, the WTRU may be configured to change the waveform type in the next slot of TBoMS/PUSCH repetition if (e.g., after) receiving an indication to change the waveform from the gNB. The WTRU may be configured to change the waveform type after N slots from receiving an indication to change the waveform type from the gNB. The WTRU may be configured to drop the ongoing transmission and uses different grant (e.g., an alternate grant). In examples, the WTRU may be configured with an alternate grant that can be used if an ongoing transmission is dropped due to waveform switching. In examples, the WTRU may be configured to continue the transmission using the already indicated waveform without changing the waveform type or stopping the transmission.

The WTRU may be configured with a MCS table that can be used for multiple waveform types (e.g., the same table can be used for CP-OFDM and DFT-s-OFDM). In examples, a MCS table may have some MCS indexes for (e.g., only for) CP-OFDM transmission, other MCS indexes for (e.g., only for) DFT-s-OFDM, and other MCS indexes for both CP-OFDM and DFT-s-OFDM. If the WTRU receives a DCI scheduling UL grant and the DCI indicates an MCS index that is for both CP-OFDM and DFT-s-OFDM, the WTRU may expect (e.g., a possibility of) waveform switching during the transmission (e.g., a TBoMS transmission).

The WTRU may stop the JCE if (e.g., after) switching the waveform type. In examples, the WTRU may continue performing JCE and delay the waveform switching until the start of the next JCE window.

Examples of power control adjustment(s) if (e.g., after) receiving waveform switching indication(s) are provided herein. The WTRU may be configured to transmit a number of UL transmissions using a first waveform type and may receive an indication to switch the waveform to transmit using a second waveform type. During the transmissions using the first waveform type, the WTRU may receive a transmit power control (TPC) command from the gNB. The WTRU may adjust/translate the TPC value received if (e.g., while) transmitting using the first waveform to calculate the “equivalent TPC.” The “equivalent TPC” may be used to calculate the transmission power to transmit with if using the second waveform type. To adjust/translate the TPC value, the gNB may provide the WTRU with Maximum Power Reduction (MPR). The WTRU may be configured with a mapping table between a TPC command received if transmitting using the first waveform and a TPC command to use if transmitting using the second waveform type. Such mapping may be a table configured to the WTRU that depends on the configured MPR. The WTRU may be provided with an updated (e.g., new) TPC command from the gNB if the waveform switching is indicated. In examples, the WTRU may receive an updated (e.g., new) TPC command in the DCI indicating the waveform switching to the WTRU.

The WTRU may be configured to keep the accumulated TPC regardless of the indicated waveform and use an updated (e.g., new) Pcmax for scaling depending on the indicated waveform. In examples, the WTRU may be configured with multiple Pcmaxs. Each Pcmax (e.g., of the multiple Pcmaxs) may be for a different waveform and may be applied depending on the waveform used for a UL transmission. The WTRU may be configured to reset the TPC if the waveform switching occurs.

Waveform indication examples are provided herein. A waveform may be determined from a combined MAC CE and DCI. The WTRU may (e.g., may first) receive signaling such as a MAC CE indicating a mode of operation for waveform switching and associated parameters. The WTRU may (e.g., may further) receive a DCI for a UL transmission and determine an applicable waveform for the transmission based on at least one field of the DCI. The interpretation of the at least one field of the DCI depends on the mode of operation and associated parameters received from the MAC CE. The WTRU may (e.g., may also) transmit a PUSCH from a configured grant and determine an applicable waveform based on the MAC CE and at least one property or configuration aspect of the configured grant.

In examples, the MAC CE may indicate a mode of operation where the WTRU determines the waveform based on a legacy.

In examples, the MAC CE may indicate a mode of operation in which at least one field of the DCI explicitly indicates a waveform. Such field(s) may be a new field or an existing field repurposed to indicate (e.g., additionally indicate) a waveform. The field(s) may include a time domain resource assignment field or a modulation and coding scheme field. Possible values (e.g., each possible value) of the field(s) may indicate a waveform (e.g., in addition to the other information indicated by the field).

In examples, the MAC CE may indicate a mode of operation in which the WTRU determines the waveform from at least one property of the transmission (e.g., such as RA type, RB allocation, MCS, number of repetitions or slots, DMRS, number of layers, etc.). The MAC CE may (e.g., may also) include parameters in support of this determination such as at least one of: a MCS threshold, where the WTRU may determine a DFT-S-OFDM waveform type if a MCS is below the threshold; a threshold in number of layers, where the WTRU may determine a DFT-S-OFDM waveform type if a number of layers is below the threshold; a threshold in the frequency spacing to the edge of carrier or BWP, where the frequency spacing is defined as number of RBs between the highest RB of the allocation and the highest RB of the carrier or BWP, between the lowest RB of the allocation and the lowest RB of the carrier or BWP, where the WTRU may determine a DFT-S-OFDM waveform type if this frequency spacing is lower than the threshold. In examples, at least one threshold (e.g., as described herein) may be determined by the WTRU and signaled to the network. The WTRU may determine a maximum frequency spacing such that the difference in a Pcmax or a PHR between transmissions using different waveforms is higher than a signaled threshold. The WTRU may report this maximum frequency spacing to the network in a MAC CE such as an enhanced PHR.

Examples of waveform switching configurations for a configured grant are provided herein. The WTRU may receive a configuration applicable to a configured grant. The configuration may indicate whether the waveform type applied for the configured grant transmission is determined based on (e.g., only on) the configuration and/or activation of the configured grant or if the configured grant transmission is determined from latest received dynamic signaling indicating a change of waveform for subsequent transmissions (e.g., such as a DCI or a MAC CE). In the latter case, the configured grant configuration may (e.g., may also) include sets of parameters applicable to possible waveform types (e.g., each possible waveform type). For example, the configuration may include first and second sets of parameters for a DFT-S-OFDM waveform type and a CP-OFDM waveform type, respectively. The configuration may include an information element with a value indicating either a waveform type (or whether transform precoding is enabled or disabled) or indicating “flexible” in case the waveform type is set based on the dynamic signaling. In examples, the WTRU may determine that the waveform type is set based on dynamic signaling if the configuration includes first and second sets of parameters applicable to first and second waveform types, respectively. If the WTRU initiates a transmission of a transport block using a first waveform type and subsequently receives dynamic signaling indicating second waveform type, the WTRU may apply rate matching (e.g., puncturing or repetition) to a transmission using the second waveform type to ensure the same transport block size is associated with the first and second waveform types.

Examples of DCI interpretations in cases of a DCI size not matching the DCI size applicable for indicated waveform(s) are provided herein. The WTRU may decode a PDCCH assuming a DCI size that depends on the latest received dynamic signaling such as a DCI indicating a waveform. In examples, the WTRU may receive (e.g., first receive) a DCI indicating a DFT-S-OFDM waveform type. The WTRU determine (e.g., after reception or acknowledgement of the DCI indicating the DFT-S-OFDM) that a subsequent PDCCH is decoded assuming a DCI whose size is determined from applicable sizes of fields if a waveform type is a DFT-S-OFDM waveform type. The WTRU may (e.g., may then) receive a second DCI indicating a CP-OFDM waveform type. At least one field of the second DCI may have smaller size that the size applicable to a CP-OFDM waveform type. In examples, the field “precoding information and number of layers” may have a smaller size than the size resulting from the PUSCH configuration if a CP-OFDM waveform type is enabled. The WTRU may perform at least one of the following to determine the applicable information from the DCI field (e.g., if the field “precoding information and number of layers” has a smaller size than the size resulting from the PUSCH configuration if the CP-OFDM waveform type is enabled): starting from the table applicable to a CP-OFDM waveform type (transform precoder disabled), remove entries of the table until the size of the reduced table matches the number of values that can be indicated from the field, maintaining the same order for the surviving entries where the entries can be removed using a priority order based on a number of layers (e.g., remove highest number of layers first); or use a table applicable to a DFT-S-OFDM waveform type (transform precoder enabled).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), the WTRU comprising:
a processor configured to:
receive a first message, wherein the first message indicates that a cell supports dynamic waveform switching;
select the cell based at least on that the cell supports dynamic waveform switching;
transmit a preamble to the cell, wherein the preamble transmission indicates a capability of the WTRU to support dynamic waveform switching;
receive a second message from the cell, wherein the second message indicates a waveform type to use for transmitting a third message; and
transmit the third message using the waveform type.

17. The WTRU of claim 16, wherein the preamble transmission indicates the capability of the WTRU to support dynamic waveform switching via at least one of: a resource used for the preamble transmission, a preamble sequence, or a transmission occasion used for the preamble transmission.

18. The WTRU of claim 16, wherein the selection of the cell is further based on a measurement of the cell being below a threshold.

19. The WTRU of claim 16, wherein the waveform type is a direct fourier transform spread orthogonal frequency-division multiplexing (DFT-s-OFDM) waveform type.

20. The WTRU of claim 16, wherein the cell is a second cell, the waveform type is a second waveform type, and the processor is further configured to:
prior to receiving the first message, communicate with a first cell using a first waveform type.

21. The WTRU of claim 20, wherein the second waveform type is a DFT-s-OFDM waveform type.

22. The WTRU of claim 16, wherein the third message is transmitted via a physical uplink shared channel (PUSCH).

23. The WTRU of claim 16, wherein the first message is received via a radio resource control (RRC) transmission or a system information block (SIB) transmission.

24. The WTRU of claim 16, wherein:
the first message is received from a first cell, and
the cell is a second cell, wherein the second cell is one of a number of neighbor cells.

25. The WTRU of claim 24, wherein:
one of the number of neighbor cells is a third cell that does not support dynamic waveform switching,
a respective measurement of each cell of the number of neighbor cells is below a threshold, and
the selection of the second cell is further based on the third cell not supporting dynamic waveform switching.

26. A method associated with a wireless transmit/receive unit (WTRU), the method comprising:
receiving a first message, wherein the first message indicates that a cell supports dynamic waveform switching;
selecting the cell based at least on that the cell supports dynamic waveform switching;
transmitting a preamble to the cell, wherein the preamble transmission indicates a capability of the WTRU to support dynamic waveform switching;
receiving a second message from the cell, wherein the second message indicates a waveform type to use for transmitting a third message; and
transmitting the third message using the waveform type.

27. The method of claim 26, wherein the preamble transmission indicates the capability of the WTRU to support dynamic waveform switching via at least one of: a resource used for the preamble transmission, a preamble sequence, or a transmission occasion used for the preamble transmission.

28. The method of claim 26, wherein the selection of the cell is further based on a measurement of the cell being below a threshold.

29. The method of claim 26, wherein the waveform type is a direct fourier transform spread orthogonal frequency-division multiplexing (DFT-s-OFDM) waveform type.

30. The method of claim 26, wherein the cell is a second cell and the waveform type is a second waveform type, further comprising:
prior to receiving the first message, communicating with a first cell using a first waveform type.

31. The method of claim 30, wherein the second waveform type is a DFT-s-OFDM waveform type.

32. The method of claim 26, wherein the third message is transmitted via a physical uplink shared channel (PUSCH).

33. The method of claim 26, wherein the first message is received via a radio resource control (RRC) transmission or a system information block (SIB) transmission.

34. The method of claim 26, wherein:
the first message is received from a first cell, and
the cell is a second cell, wherein the second cell is one of a number of neighbor cells.

35. The method of claim 34, wherein:
one of the number of neighbor cells is a third cell that does not support dynamic waveform switching,
a respective measurement of each cell of the number of neighbor cells is below a threshold, and
the selection of the second cell is further based on the third cell not supporting dynamic waveform switching.
